(19) United States
(12) Patent Application Publication
(10) Pub. No.: US 2024/0336791 A1
(43) Pub. Date: Oct. 10, 2024

(54) METAL INK, METHOD FOR MANUFACTURING METAL INK, AND METHOD FOR MANUFACTURING METAL LAYER

(71) Applicant: MITSUBISHI MATERIALS CORPORATION, Tokyo (JP)

(72) Inventors: Ryuji Uesugi, Ibaraki (JP); Tomohiko Yamaguchi, Ibaraki (JP); Riku Ebisawa, Ibaraki (JP)

(73) Assignee: MITSUBISHI MATERIALS CORPORATION, Tokyo (JP)

(21) Appl. No.: 18/293,828

(22) PCT Filed: Aug. 1, 2022
(86) PCT No.: PCT/JP2022/029454

§ 371 Date: Jan. 31, 2024

(30) Foreign Application Priority Data
Aug. 3, 2021 (JP) 2021-127796

(51) Int. Cl. C09D 11/037; B41M 5/00; B41M 7/00; C09D 11/033

(52) U.S. Cl. CPC C09D 11/037; B41M 5/0047; B41M 7/009; C09D 11/033

(57) ABSTRACT

Agglomeration of metal particles is to be suppressed. A metal ink contains metal particles, a solvent, and a polyhydric alcohol containing two or more OH groups and soluble in water and ethanol.

### FIELD

The present invention relates to a metal ink, a method for manufacturing a metal ink, and a method for manufacturing a metal layer.

### BACKGROUND

As an example of forming a metal layer on a member, Patent Literature 1 describes forming a solder layer on a member. For example, Patent Literature 2 describes forming a metal layer using silver paste. Silver paste can be sintered under relatively low temperature conditions, and the melting point of a bonding layer formed after sintering is equivalent to that of silver. The metal layer formed of the sintered silver paste therefore has excellent heat resistance and can be used stably even in high-temperature environments and large-current applications. On the other hand, copper paste is sometimes used from the viewpoint of material cost, for example, as disclosed in Patent Literature 3.

In forming a metal layer in this way, a metal ink in which metal particles are dispersed in a liquid may be used instead of a metal paste such as copper paste. The metal ink may be advantageous from a manufacturing standpoint because the metal ink can be ejected, for example, from nozzles.

### CITATION LIST

### Patent Literature

Patent Literature 1: Japanese Patent Application Laid-open No. 2004-172378

Patent Literature 2: Japanese Patent No. 6531547

Patent Literature 3: Japanese Patent Application Laid-open No. 2019-67515

### SUMMARY

### Technical Problem

In such a metal ink, metal particles may agglomerate, causing degradation in characteristics of products, such as decrease in denseness of the metal layer. It is therefore required to suppress the agglomeration of metal particles.

The present invention was made in view of the above, and it is an object to provide a metal ink in which agglomeration of metal particles is suppressed, a method for manufacturing a metal ink, and a method for manufacturing a metal layer.

### Solution to Problem

In order to solve the above problem, a metal ink according to the present disclosure includes: metal particles; a solvent; and a polyhydric alcohol containing two or more OH groups and soluble in water and ethanol.

The polyhydric alcohol is preferably contained in an amount of 0.01% or more and 20.0% or less in mass ratio to a total amount of the metal ink.

The metal particles are preferably contained in an amount of 1.0% or more and 50.0% or less in mass ratio to a total amount of the metal ink.

The polyhydric alcohol preferably has a melting point of 30° C. or more.

The solvent preferably includes water.

The solvent preferably includes ethanol.

Preferably, the solvent includes a high-boiling solvent that contains one or more OH groups, has a boiling point of 150° C. or more, and is a liquid hardly soluble or insoluble in water.

The metal particles are preferably at least one of copper and silver.

In order to solve the above problem, a method for manufacturing a metal ink according to the present disclosure includes metal particles, a solvent, and a polyhydric alcohol containing two or more OH groups and soluble in water and ethanol to manufacture a metal ink containing the metal particles, the solvent, and the polyhydric alcohol.

The method for manufacturing a metal ink according to the present disclosure preferably includes mixing the metal particles with an aqueous solution of the polyhydric alcohol to produce a first metal ink that is a metal ink containing the metal particles, water, and the polyhydric alcohol.

The method for manufacturing a metal ink according to the present disclosure preferably includes mixing the first metal ink with ethanol to produce a second metal ink that is a metal ink containing the metal particles, the ethanol, and the polyhydric alcohol.

The method for manufacturing a metal ink according to the present disclosure preferably includes mixing the second metal ink with a high-boiling solvent that contains one or more OH groups, has a boiling point of 150° C. or more, and is a liquid hardly soluble or insoluble in water, to produce a third metal ink that is a metal ink containing the metal particles, the high-boiling solvent, and the polyhydric alcohol.

A method for manufacturing a metal layer according to the present disclosure includes heating the metal ink according to any one of claims 1 to 8 to form a metal layer.

### Advantageous Effects of Invention

According to the present invention, agglomeration of metal particles can be suppressed.

### BRIEF DESCRIPTION OF DRAWINGS

FIG. 1 is a schematic diagram of a metal ink according to the present embodiment.

FIG. 2 is a flowchart illustrating a method for manufacturing a metal ink according to the present embodiment.

### DESCRIPTION OF EMBODIMENTS

The present invention will be described in detail below with reference to the drawings. It should be noted that the present invention is not limited by the following modes for carrying out the invention (hereinafter referred to as “embodiments”). In addition, the components in the following embodiments include those that can be readily conceived by those skilled in the art, those that are substantially identical, and those that come within the range of equivalence. Furthermore, the components disclosed in the following embodiments can be combined as appropriate. Numerical values except 0 (zero) include the rounding range.

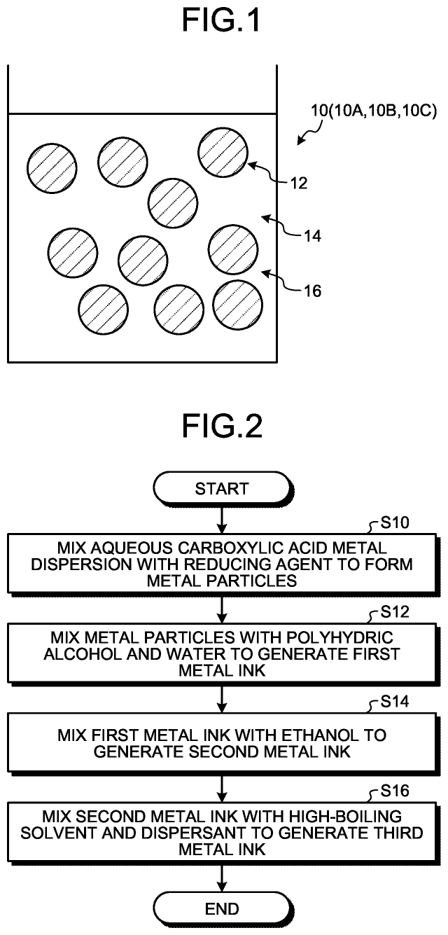

FIG. 1 is a schematic diagram of a metal ink according to the present embodiment. As illustrated in FIG. 1, a metal ink 10 contains metal particles 12, a polyhydric alcohol 14, and a solvent 16. The metal ink 10 refers to an ink-like substance in which the metal particles 12 are not dissolved in the solvent 16, which is a liquid, but the metal particles 12 are present in the solid form in the solvent 16. In the metal ink 10, the metal particles 12 may settle in the solvent 16, or the metal particles 12 may be dispersed.

The metal ink 10 is used to form a metal layer on a member (for example, to form wiring). For example, the metal ink 10 is ejected from a nozzle onto a base material (a film of resin, metal or the like, or a substrate made of resin, metal, ceramic or a composite thereof) and dried, and thereafter further heated to sinter or melt the metal particles 12 while removing other components, and then cooled, whereby a metal layer formed of the metal component of the metal particles 12 is formed on the base material. However, the metal ink 10 is not limited to this application and may be used in any applications.

### Metal Particles

The metal particles 12 are particles of metal. In the present embodiment, the metal particles 12 are preferably copper or silver particles and may include both copper and silver. In other words, the metal particles 12 are preferably particles of at least one of copper and silver.

It is preferable that the metal particles 12 have a particle size (peak value of particle size distribution (number of particles)) of 10 nm or more and 1000 nm or less. The particle size can be determined as the peak value of particle size distribution (number of particles) of the metal particles 12, using a particle size measuring device (Zetasizer Nano Series ZSP available from Malvern Panalytical Ltd).

If the particle size is 10 nm or less, the specific surface area increases in inverse proportion to the particle size. As a result, the effect of surface oxidation may increase, and the sinterability of a coating film obtained using the metal particles 12 may deteriorate. On the other hand, if the particle size of the metal particles 12 is 1000 nm or more, the particle size becomes too large. As a result, the metal particles 12 may easily settle and separate in the ink when dispersed in the solvent. The particle size of the metal particles 12 is preferably in the range of 30 nm to 500 nm, and particularly preferably in the range of 30 nm to 300 nm.

The BET specific surface area of the metal particles 12 can be determined by measuring the amount of nitrogen gas adsorbed by the metal particles 12 using a specific surface area measuring device (QUANTACHROME AUTOSORB-1 available from Quantachrome Instruments). The BET specific surface area of the metal particles 12 is preferably in the range of 2.0 m²/g to 8.0 m²/g, more preferably in the range of 3.5 m²/g to 8.0 m²/g, and particularly preferably in the range of 4.0 m²/g to 8.0 m²/g. The shape of the metal particles 12 is not limited to a spherical shape and may be a needle-like or flat plate-like shape.

It is preferable that the surface of the metal particles 12 is partially or entirely coated with an organic substance. The coating of an organic substance suppresses oxidation of the metal particles 12 and further reduces the possibility of deterioration of sinterability due to oxidation of the metal particles 12. It can be said that the organic substance coating the metal particles 12 is not formed by the polyhydric alcohol 14 or the solvent 16 and is not derived from the polyhydric alcohol 14 or the solvent 16. It can also be said that the organic substance coating the metal particles 12 is not a metal oxide (copper oxide or silver oxide) formed by oxidation of the metal.

The coating of the metal particles 12 with an organic substance can be observed by analyzing the surface of the metal particles 12 using time-of-flight secondary ion mass spectrometry (TOF-SIMS). For example, when the metal particles 12 are copper, the ratio of the detected amount of C₃H₃O₃⁻ ions to the detected amount of Cu⁺ ions detected by analyzing the surface of the metal particles 12 using time-of-flight secondary ion mass spectrometry (C₃H₃O₃⁻/Cu⁺ ratio) is preferably 0.001 or more. The C₃H₃O₃⁻/Cu⁺ ratio is even more preferably in the range of 0.05 to 0.2. The surface of the metal particles 12 in this analysis refers to the surface of the metal particles 12 including the coating of the organic substance (that is, the surface of the organic substance), rather than the surface of the metal particles 12 when the organic substance is removed from the metal particles 12. When the metal particles 12 are silver, the ratio of the detected amount of C₃H₃O₃⁻ ions to the detected amount of Ag⁺ ions detected by analyzing the surface of the metal particles 12 using time-of-flight secondary ion mass spectrometry (C₃H₃O₃⁻/Ag⁺ ratio) is preferably 0.001 or more and even more preferably in the range of 0.05 to 0.2.

When the metal particles 12 are copper, C₃H₄O₂⁻ ions or ions of C₅ or more may be detected by analyzing the surface using time-of-flight secondary ion mass spectrometry. The ratio of the detected amount of C₃H₄O₂⁻ ions to the detected amount of Cu⁺ ions (C₃H₄O₂⁻/Cu⁺ ratio) is preferably 0.001 or more. The ratio of the detected amount of ions of C₅ or more to the detected amount of Cu⁺ ions (ions of C₅ or more/Cu ratio) is preferably less than 0.005. When the metal particles 12 are silver, the ratio of the detected amount of C₃H₄O₂⁻ ions to the detected amount of Ag⁺ ions (C₃H₄O₂⁻/Ag⁺ ratio) is preferably 0.001 or more. It can be said that the ratio of the detected amount of ions of C₅ or more to the detected amount of Ag⁺ ions (ions of C₅ or more/Ag⁺ ratio) is preferably less than 0.005.

The C₃H₃O₃⁻ ions, C₃H₄O₂⁻ ions, and ions of C₅ or more detected in time-of-flight secondary ion mass spectrometry originate from the organic substance coating the surface of the metal particles 12. Therefore, when the C₃H₃O₃⁻/Cu⁺ ratio and the C₃H₄O₂⁻/Cu⁺ ratio are each 0.001 or more, the surface of the metal particles 12 is less likely to oxidize and the metal particles 12 are less likely to agglomerate. Furthermore, when the C₃H₃O₃⁻/Cu⁺ ratio and the C₃H₄O₂⁻/Cu⁺ ratio are 0.2 or less, oxidation and agglomeration of the metal particles 12 can be suppressed without excessively reducing the sinterability of the metal particles 12, and the generation of decomposition gas of the organic substance during heating can also be suppressed. As a result, a bonding layer with fewer voids can be formed. In order to further improve the oxidation resistance of the metal particles 12 during storage and to further improve the sinterability at low temperatures, the C₃H₃O₃⁻/Cu⁺ ratio and the C₃H₄O₂⁻/Cu⁺ ratio are preferably in the range of 0.08 to 0.16. Furthermore, when the ions of C₅ or more/Cu⁺ ratio is 0.005 or more, a large amount of organic substance with a relatively high desorption temperature is present on the particle surface, and as a result, sinterability is not sufficiently developed and a strong bonding layer is less likely to be produced. The ions of C₅ or more/Cu⁺ ratio is preferably less than 0.003. When the metal particles 12 are silver, the C₃H₃O₃⁻/Ag⁺ ratio and the C₃H₄O₂⁻/Ag⁺ ratio are preferably in the range of 0.08 to 0.16. Furthermore, when the ions of C₅ or more/Ag⁺ ratio is 0.005 or more , a large amount of organic substance with a relatively high desorption temperature is present on the particle surface, and as a result, sinterability is not sufficiently developed and a strong bonding layer is less likely to be produced. It can be said that the ions of C₅ or more/Ag⁺ ratio is preferably less than 0.003.

The organic substance coating the metal particles 12 is preferably a carboxylic acid derived from a carboxylic acid metal used in the production of the metal particles 12. The method for manufacturing the metal particles 12 coated with a carboxylic acid-derived organic substance will be described later. The amount of coating of the organic substance on the metal particles 12 is preferably in the range of 0.5% by mass to 2.0% by mass with respect to 100% by mass of the metal particles, more preferably in the range of 0.8% by mass to 1.8% by mass, and even more preferably in the range of 0.8% by mass to 1.5% by mass. With the amount of coating of the organic substance of 0.5% by mass or more, the metal particles 12 can be uniformly coated with the organic substance, and oxidation of the metal particles 12 can be suppressed more reliably. On the other hand, with the amount of coating of the organic substance of 2.0% by mass or less, it is possible to suppress the formation of voids in the sintered metal particles (bonding layer) due to gases generated by the decomposition of the organic substance by heating. The amount of coating of the organic substance can be measured using commercially available equipment. For example, the amount of coating can be measured using a thermogravimetry differential thermal analyzer TG8120-SL (Rigaku Corporation). In this case, for example, metal particles from which water has been removed by freeze-drying are used as a sample. Measurement is performed in nitrogen (Grade 2) gas to suppress oxidation of the metal particles, and the ratio of weight reduction by heating from 250° C. to 300° C. at a temperature increase rate of 10° C./min can be defined as the amount of coating of the organic substance. That is, the amount of coating=(sample weight after measurement)/(sample weight before measurement)×100 (wt %). The measurement may be performed three times each with metal particles in the same lot, and the arithmetic mean may be considered as the amount of coating.

When the metal particles 12 are heated for 30 minutes at a temperature of 300° C. in an inert gas atmosphere such as argon gas, it is preferable that 50% by mass or more of the organic substance is decomposed. The carboxylic acid-derived organic substance generates carbon dioxide gas, nitrogen gas, acetone evaporation gas, and water vapor during decomposition.

### Polyhydric Alcohol

The polyhydric alcohol 14 is a polyhydric alcohol that contains two or more OH groups and is soluble in water and ethanol. Furthermore, it is preferable that the polyhydric alcohol 14 has a melting point of 30° C. or more.

The polyhydric alcohol 14 may be, for example, at least one of 2,2-dimethyl-1,3-propanediol, 2,5-dimethyl-2,5-hexanediol, 2-hydroxymethyl-2-methyl-1,3-propanediol, 1-phenyl-1,2-ethanediol, 1,1,1-tris(hydroxymethyl)propane, erythritol, pentaerythritol, ribitol, resorcinol, (pyro) catechol, 5-methylresorcinol, pyrogallol, 1,2,3-cyclohexanetriol, and 1,3,5-cyclohexanetriol.

The polyhydric alcohol 14 is a non-electrolyte and is present in the metal ink 10 in a state of being dissolved in the solvent 16 (in a state in which molecules of the polyhydric alcohol 14 are dispersed in the solvent 16). However, the polyhydric alcohol 14 may be present in any form in the metal ink 10 and may be present in a state of not being dissolved in the solvent 16.

Since the polyhydric alcohol 14 is included in the metal ink 10, the polyhydric alcohol 14 coordinates around the metal particles 12 to properly suppress agglomeration of the metal particles 12. In other words, in the present embodiment, it can be said that it is preferable that the polyhydric alcohol 14 coordinates around the metal particles 12.

### Solvent

The solvent 16 is a liquid (medium) for dispersing the metal particles 12. The details of the solvent 16 will be described later.

### Metal Ink

The amount of polyhydric alcohol 14 in the metal ink 10 is preferably 0.01% or more and 20.0% or less, more preferably 0.05% or more and 20.0% or less, and even more preferably 0.05% or more and 10.0% or less, in mass ratio to the entire metal ink 10. The amount of polyhydric alcohol 14 in this range allows the metal particles 12 to be properly dispersed while preventing the concentration of the metal particles 12 from becoming too low.

The amount of metal particles 12 in the metal ink 10 is preferably 1.0% or more and 50.0% or less, more preferably 5.0% or more and 50.0% or less, and even more preferably 5.0% or more and 30.0% or less, in mass ratio to the entire metal ink 10. The amount of metal particles 12 in this range is advantageous from a manufacturing standpoint, for example, in that ejectability by nozzles is improved, because reduction in flowability of the metal ink 10 can be suppressed while keeping a sufficient concentration of metal particles 12.

The amount of solvent 16 in the metal ink 10 is preferably 50.0% or more and 99.0% or less, more preferably 50.0% or more and 95.0% or less, and even more preferably 60.0% or more and 95.0% or less, in mass ratio to the entire metal ink 10. The amount of solvent 16 in this range is advantageous from a manufacturing standpoint, for example, in that ejectability by nozzles is improved, because reduction in flowability of the metal ink 10 can be suppressed while keeping a sufficient concentration of metal particles 12.

The metal ink 10 described above can have variations in composition of the solvent 16. The metal inks 10 with the solvents 16 of different compositions will be described below.

### First Metal Ink

One of the metal inks 10 with the solvents 16 of different compositions is denoted as a first metal ink 10A. In the first metal ink 10A, the solvent 16 is water. The first metal ink 10A is a mixture of metal particles 12 while the polyhydric alcohol 14 is dissolved in water as the solvent 16. In other words, the first metal ink 10A contains the metal particles 12 in an aqueous solution of polyhydric alcohol 14.

The amount of polyhydric alcohol 14 in the first metal ink 10A is preferably 0.1% or more and 20.0% or less, more preferably 0.5% or more and 20.0% or less, and even more preferably 1.0% or more and 10.0% or less, in mass ratio to the entire first metal ink 10A. The amount of polyhydric alcohol 14 in this range allows the metal particles 12 to be properly dispersed while preventing the concentration of the metal particles 12 from becoming too low.

The amount of metal particles 12 in the first metal ink 10A is preferably 1.0% or more and 50.0% or less, more preferably 5.0% or more and 50.0% or less, and even more preferably 5.0% or more and 30.0% or less, in mass ratio to the entire first metal ink 10A. The amount of metal particles 12 in this range is advantageous from a manufacturing standpoint, for example, in that ejectability by nozzles is improved, because reduction in flowability of the first metal ink 10A can be suppressed while keeping a sufficient concentration of metal particles 12.

In the present embodiment, it is preferable that the first metal ink 10A contains no substances other than the metal particles 12, the polyhydric alcohol 14, and the solvent 16 which is water, except for inevitable impurities. However, the present embodiment is not limited thereto and the first metal ink 10A may contain additives (dispersant, adhesion-applying agent, rheology adjuster, anti-rust agent, and the like) other than the metal particles 12, the polyhydric alcohol 14, and the solvent 16 which is water.

### Second Metal Ink

One of the metal inks 10 with the solvents 16 of different compositions is denoted as a second metal ink 10B. The second metal ink 10B contains ethanol as the solvent 16. To be more specific, the main solvent which is the main component of the solvent 16 is ethanol. As used herein the main solvent refers to a content more than 50% in mass ratio in the entire solvent 16. The second metal ink 10B may contain, as the solvent 16, a solvent other than ethanol which is the main solvent, and in the present embodiment, may contain water. The second metal ink 10B is a mixture of metal particles 12 while the polyhydric alcohol 14 is dissolved in the solvent 16. In other words, for example, the second metal ink 10B contains the metal particles 12 in an aqueous solution of polyhydric alcohol 14 and ethanol.

The amount of polyhydric alcohol 14 in the second metal ink 10B is preferably 0.01% or more and 20.0% or less, more preferably 0.1% or more and 10.0% or less, and even more preferably 0.1% or more and 5.0% or less, in mass ratio to the entire second metal ink 10B. The amount of polyhydric alcohol 14 in this range allows the metal particles 12 to be properly dispersed while preventing the concentration of the metal particles 12 from becoming too low.

The amount of metal particles 12 in the second metal ink 10B is preferably 1.0% or more and 50.0% or less, more preferably 5.0% or more and 50.0% or less, and even more preferably 5.0% or more and 30.0% or less, in mass ratio to the entire second metal ink 10B. The amount of metal particles 12 in this range is advantageous from a manufacturing standpoint, for example, in that ejectability by nozzles is improved, because reduction in flowability of the second metal ink 10B can be suppressed while keeping a sufficient concentration of metal particles 12.

The amount of ethanol in the second metal ink 10B is preferably 50.0% or more and 99.0% or less, more preferably 50.0% or more and 95.0% or less, and even more preferably 60.0% or more and 95.0% or less, in mass ratio to the entire second metal ink 10B. The amount of ethanol in this range is advantageous from a manufacturing standpoint, for example, in that ejectability by nozzles is improved, because reduction in flowability of the second metal ink 10B can be suppressed while keeping a sufficient concentration of metal particles 12.

In the present embodiment, it is preferable that the second metal ink 10B contains no substances other than the metal particles 12, the polyhydric alcohol 14, and the solvent 16 (herein water and ethanol), except for inevitable impurities. However, the present embodiment is not limited thereto and the second metal ink 10B may contain additives (dispersant, adhesion-applying agent, rheology adjuster, anti-rust agent, and the like) other than the metal particles 12, the polyhydric alcohol 14, and the solvent 16.

In a metal ink containing ethanol as the main solvent, ethanol may cause agglomeration of metal particles. In contrast, in the second metal ink 10B, since the polyhydric alcohol 14 is mixed, for example, the polyhydric alcohol 14 coordinates around the metal particles 12 to suppress agglomeration of the metal particles 12.

### Third Metal Ink

One of the metal inks 10 with the solvents 16 of different compositions is denoted as a third metal ink 10C. The third metal ink 10C contains a high-boiling solvent as the solvent 16. To be more specific, the main solvent which is the main component of the solvent 16 is a high-boiling solvent. For example, the third metal ink 10C contains the metal particles 12 while the polyhydric alcohol 14 is dissolved in the solvent 16. The third metal ink 10C may contain, as the solvent 16, a solvent other than a high-boiling solvent which is the main solvent. The third metal ink 10C may contain at least one of water and ethanol, and in the present embodiment contains both water and ethanol.

The high-boiling solvent contains one or more OH groups, has a boiling point of 150° C. or more, and is a liquid hardly soluble or insoluble in water. The high-boiling solvent is preferably a solvent classified as a non-water-soluble liquid in the Cabinet Order on Regulation of Hazardous Materials in the Fire Service Act, Appendix 3. The high-boiling solvent is preferably an organic solvent, for example, at least one of α-terpineol and 2-ethyl-1,3-hexanediol. Both solvents may include isomers.

The amount of polyhydric alcohol 14 in the third metal ink 10C is preferably 0.01% or more and 5.0% or less, more preferably 0.03% or more and 5.0% or less, and even more preferably 0.03% or more and 3.0% or less, in mass ratio to the entire third metal ink 10C. The amount of polyhydric alcohol 14 in this range allows the metal particles 12 to be properly dispersed while preventing the concentration of the metal particles 12 from becoming too low.

The amount of metal particles 12 in the third metal ink 10C is preferably 1.0% or more and 50.0% or less, more preferably 5.0% or more and 50.0% or less, and even more preferably 5.0% or more and 30.0% or less, in mass ratio to the entire third metal ink 10C. The amount of metal particles 12 in this range is advantageous from a manufacturing standpoint, for example, in that ejectability by nozzles is improved, because reduction in flowability of the third metal ink 10C can be suppressed while keeping a sufficient concentration of metal particles 12.

The amount of high-boiling solvent in the third metal ink 10C is preferably 10.0% or more and 99.0% or less, more preferably 15.0% or more and 95.0% or less, and even more preferably 20.0% or more and 95.0% or less, in mass ratio to the entire third metal ink 10C. The amount of high-boiling solvent in this range is advantageous from a manufacturing standpoint, for example, in that ejectability by nozzles is improved, because reduction in flowability of the third metal ink 10C can be suppressed while keeping a sufficient concentration of metal particles 12.

It is preferable that the third metal ink 10C contains a dispersant, which is a component other than the metal particles 12, the polyhydric alcohol 14, and the solvent 16. Examples of the dispersant include cationic dispersants, anionic dispersants, nonionic dispersants, and amphoteric dispersants. Among those, examples of the anionic dispersants include carboxylic acid dispersants, sulfonic acid dispersants, phosphoric acid dispersants, and in particular, phosphate ester compounds are suitable as the phosphoric acid dispersants. The molecular weight of the phosphate ester compound used as a dispersant is preferably 200 or more and 2000 or less, more preferably 200 or more and 1500 or less, and even more preferably 200 or more and 1000 or less. The molecular weight of 200 or more provides sufficient hydrophobicity to achieve satisfactory dispersibility of metal particles in the high-boiling solvent. The molecular weight of 2000 or less enables decomposition and reaction at the targeted heating temperature (approximately 200 to 350° C.) to eliminate the possibility of hindering sintering of the metal particles. Any phosphate ester compound can be used as a dispersant, and examples include polyoxyethylene alkyl ether phosphate esters such as laureth-n-phosphate, oleth-n-phosphate, steareth-n-phosphate (n=2 to 10), and alkyl phosphate esters. One of these may be used or two or more may be used as a dispersant.

The amount of dispersant in the third metal ink 10C is preferably 0.01% or more and 5.0% or less, more preferably 0.1% or more and 5.0% or less, and even more preferably 0.1% or more and 3.0% or less, in mass ratio to the entire third metal ink 10C. The amount of dispersant in this range can properly suppress agglomeration of the metal particles 12.

In the present embodiment, it is preferable that the third metal ink 10C contains no substances other than the metal particles 12, the polyhydric alcohol 14, the solvent 16 (herein, water, ethanol, and high-boiling solvent), and the dispersant, except for inevitable impurities. However, the present embodiment is not limited thereto. The third metal ink 10C does not necessarily contain a dispersant or may contain additives (adhesion-applying agent, rheology adjuster, anti-rust agent, and the like) other than the metal particles 12, the polyhydric alcohol 14, the solvent 16, and the dispersant.

In a metal ink containing a high-boiling solvent as the main solvent, the high-boiling solvent may cause agglomeration of the metal particles 12. In contrast, in the third metal ink 10C, since the polyhydric alcohol 14 is mixed, for example, the polyhydric alcohol 14 coordinates around the metal particles 12 to suppress agglomeration of the metal particles 12.

### Method for Manufacturing Metal Ink

A method for manufacturing the metal ink 10 described above will now be described. FIG. 2 is a flowchart illustrating a method for manufacturing a metal ink according to the present embodiment.

### Production of Metal Particles

As illustrated in FIG. 2, in this production method, the metal particles 12 are formed by mixing an aqueous carboxylic acid metal dispersion with a reducing agent (step S10). Specifically, first, an aqueous dispersion of a carboxylic acid metal (for example, copper carboxylate) is prepared, and then a pH adjuster is added to this aqueous carboxylic acid metal dispersion to adjust the pH to 2.0 or more and 7.5 or less. Subsequently, to this pH-adjusted aqueous carboxylic acid metal dispersion, a hydrazine compound in an amount 1.0 to 1.2 times the equivalent amount that can reduce metal ions is added as a reducing agent and mixed under an inert gas atmosphere. The resulting mixture is heated to a temperature of 60° C. or more and 80° C. or less and held for 1.5 hours or longer and 2.5 hours or shorter under an inert gas atmosphere. This process reduces the metal ions leached from the carboxylic acid metal to form metal particles 12 and forms a metal acid-derived organic substance on the surface of the metal particles 12. As the carboxylic acid, glycolic acid, citric acid, malic acid, maleic acid, malonic acid, fumaric acid, succinic acid, tartaric acid, oxalic acid, phthalic acid, benzoic acid, and salts thereof are used. As the reducing agent, a hydrazine compound is used, but hydrazine, ascorbic acid, oxalic acid, formic acid, and salts thereof may be used.

### Production of Metal Particles: Copper Particles

In the following, the method for manufacturing metal particles 12 when the metal particles 12 are copper particles will be described. An aqueous dispersion of copper carboxylate can be prepared by adding a powdered carboxylic acid metal to pure water such as distilled water or ion-exchanged water at a concentration of 25% by mass or more and 40% by mass or less, stirring with a stirring blade, and dispersing uniformly. Examples of the pH adjuster include triammonium citrate, ammonium hydrogen citrate, and citric acid. Among these, triammonium citrate is preferred because it can mildly adjust the pH. The pH of the aqueous copper carboxylate dispersion is set to 2.0 or more in order to accelerate the leaching rate of copper ions leached from copper carboxylate and to allow the formation of copper particles to proceed quickly to obtain the target fine copper particles. The pH is set to 7.5 or less in order to prevent the leached metal ions from becoming copper(II) hydroxide and to increase the yield of copper particles. Setting the pH to 7.5 or less can prevent the reducing power of the hydrazine compound from becoming excessively high and facilitates formation of the target copper particles. The pH of the aqueous copper carboxylate dispersion is preferably adjusted to within a range of 4 to 6.

The reduction of copper carboxylate by the hydrazine compound is performed under an inert gas atmosphere. This is to prevent oxidation of copper ions leached into the liquid. Examples of the inert gas include nitrogen gas and argon gas. The hydrazine compound has the advantages of producing no residue after the reduction reaction when reducing copper carboxylate under acidic conditions, being relatively safe, and being easy to handle. Examples of the hydrazine compound include hydrazine monohydrate, anhydrous hydrazine, hydrazine hydrochloride, and hydrazine sulfate. Among these hydrazine compounds, hydrazine monohydrate and anhydrous hydrazine, which do not contain components such as sulfur and chlorine that can be impurities, are preferred.

Generally, copper formed in an acidic solution of less than pH 7 will dissolve. In the present embodiment, however, the hydrazine compound as a reducing agent is added and mixed with an acidic solution of less than pH 7 to form copper particles in the resulting mixture. Thus, the carboxylic acid-derived component generated from copper carboxylate quickly coats the surface of the copper particles to suppress dissolution of the copper particles. It is preferable that the aqueous dispersion of copper carboxylate after the pH adjustment is set to 50° C. or more and 70° C. or less to facilitate the progress of the reduction reaction.

The mixture of the hydrazine compound is heated to a temperature of 60° C. or more and 80° C. or less and held for 1.5 hours or longer and 2.5 hours or shorter under an inert gas atmosphere in order to form copper particles and to form a coating of an organic substance on the surface of the formed copper particles. Heating and holding in an inert gas atmosphere is to prevent oxidation of the formed copper particles. The starting material, that is, copper carboxylate, usually contains approximately 35% by mass of copper. By adding a hydrazine compound as a reducing agent to an aqueous carboxylic acid dispersion containing a copper component in such a degree, heating the mixture to the above temperatures, and holding the mixture for the above period of time, the formation of copper particles and the formation of an organic substance on the surface of the copper particles proceed in a balanced manner, resulting in copper particles with the amount of coating of the organic substance in the range of 0.5% by mass to 2.0% by mass with respect to 100% by mass of the copper particles. If the heating temperature is less than 60° C. and the holding time is shorter than 1.5 hours, the carboxylic acid metal may not be completely reduced, and the rate of copper particle formation may be too slow. As a result, the amount of organic substance coating the copper particles may be excessive. On the other hand, if the heating temperature exceeds 80° C. and the holding time exceeds 2.5 hours, the rate of copper particle formation may be too fast, and the amount of organic substance coating the copper particles may be too small. The preferred heating temperature is 65° C. or more and 75° C. or less, and the preferred holding time is 2 hours or longer and 2.5 hours or shorter.

A water slurry containing the metal particles 12 with a certain solid-liquid ratio (for example, solid-liquid ratio: 50/50 [% by mass]) can be obtained from the mixture of copper particles formed in the mixture under an inert gas atmosphere, for example, using a centrifuge. In some cases, the copper particles 12 having the surface coated with an organic substance can be obtained by solid-liquid separation and drying by freeze-drying or drying under reduced pressure. These copper particles have the surface coated with an organic substance and therefore is less likely to be oxidized even when stored in air.

### Production of Metal Particles: Silver Particles

The method for manufacturing metal particles 12 when the metal particles 12 are silver particles will now be described.

First, a silver carboxylate slurry is prepared by simultaneously adding an aqueous silver salt solution and an aqueous carboxylate solution dropwise into water.

When a silver carboxylate slurry is prepared, it is preferable that each of the aqueous silver salt solution, the aqueous carboxylate solution, water, and the silver carboxylate slurry is held at a predetermined temperature in the range of 20 to 90° C. Holding the temperature of each liquid at a predetermined temperature of 20° C. or more facilitates formation of silver carboxylate and can increase the particle size of silver particles. Furthermore, holding the temperature of each liquid at a predetermined temperature of 90° C. or less can prevent the silver particles from becoming coarse particles. Furthermore, it is preferable that water is stirred while the aqueous silver salt solution and the aqueous carboxylate solution are simultaneously added dropwise into the water.

As a silver salt in the aqueous silver salt solution, specifically, for example, one or two or more compounds selected from the group consisting of silver nitrate, silver chlorate, silver phosphate, and salts thereof are preferred.

As a carboxylic acid in the aqueous carboxylate solution, one or two or more compounds selected from the group consisting of glycolic acid, citric acid, malic acid, maleic acid, malonic acid, fumaric acid, succinic acid, tartaric acid, and salts thereof are preferred.

Examples of the water include ion-exchanged water and distilled water. It is particularly preferred to use ion-exchanged water because it does not contain ions that may adversely affect synthesis and its production cost is lower than that of distilled water.

Subsequently, a silver particle slurry is prepared by adding an aqueous reducing agent solution dropwise into the silver carboxylate slurry and then performing predetermined heat treatment. Herein, specifically, the predetermined heat treatment may be, for example, heat treatment of increasing the temperature to a predetermined temperature (maximum temperature) in the range of 20 to 90° C. at a temperature increase rate of 15° C./hour or less in water, holding this maximum temperature for 1 to 5 hours, and then decreasing the temperature to 30° C. or less over 30 minutes or shorter.

In the above predetermined heat treatment, setting the temperature increase rate to 15° C./hour or less can prevent the silver particles from becoming coarse particles.

Furthermore, in the above predetermined heat treatment, setting the maximum temperature to 20° C. or more facilitates reduction of silver carboxylate and can increase the particle size of silver particles. On the other hand, setting the maximum temperature to 90° C. or less can prevent silver particles from becoming coarse particles.

Furthermore, in the above predetermined heat treatment, setting the holding time at the maximum temperature to 1 hour or longer facilitates reduction of silver carboxylate and can increase the particle size of silver particles. On the other hand, setting the holding time to 5 hours or shorter can prevent silver particles from becoming coarse particles.

Furthermore, in the above predetermined heat treatment, setting the period of time for decreasing the temperature to 30° C. to 30 minutes or shorter can prevent the silver particles from becoming coarse particles.

When a silver particle slurry is prepared, it is preferable to hold the temperature of each of the silver carboxylate slurry and the aqueous reducing agent solution at a predetermined temperature in the range of 20 to 90° C. Holding the temperature of each liquid at a predetermined temperature of 20° C. or more facilitates reduction of silver carboxylate and can increase the particle size of silver powder. On the other hand, holding the temperature of each liquid at a predetermined temperature of 90° C. or less can prevent the silver powder from becoming coarse particles.

As a reducing agent in the aqueous reducing agent solution, one or two or more compounds selected from the group consisting of hydrazine, ascorbic acid, oxalic acid, formic acid, and salts thereof are preferred.

Herein, a water slurry containing silver particles with a certain solid-liquid ratio (for example, solid-liquid ratio: 50/50 [% by mass]) can be obtained by subjecting the silver particle slurry to a centrifuge to remove the liquid layer in the silver powder slurry, and dehydrate and desalinate the silver particle slurry.

In some cases, the silver particle slurry can be dried to obtain silver particles. The silver particle slurry can be dried by any method, and specific examples of the drying method include freeze-drying, drying under reduced pressure, and heat drying. The freeze-drying is a method in which the silver particle slurry is frozen in a sealed container, the inside of the sealed container is depressurized by a vacuum pump to lower the boiling point of the material to be dried, and the material to be dried is sublimated and dried at a low temperature. The drying under reduced pressure is a method in which the material to be dried is dried under reduced pressure. The heat drying is a method in which the material to be dried is dried by heating.

### Production of First Metal Ink

Subsequently, the metal particles 12 are mixed with the polyhydric alcohol 14 and water to generate the first metal ink 10A (step S12). Herein, it is preferable that the first metal ink 10A is produced by mixing the metal particles 12, the polyhydric alcohol 14, and water such that the amounts of metal particles 12 and polyhydric alcohol 14 are in the numerical ranges described above. The metal particles 12, the polyhydric alcohol 14, and water may be mixed by any method. For example, an aqueous solution of the polyhydric alcohol 14 containing the polyhydric alcohol 14 and water may be mixed with a metal slurry in which water is contained in the metal particles 12, or an aqueous solution of the polyhydric alcohol 14 may be mixed with the metal particles 12 that do not contain water.

### Production of Second Metal Ink

Subsequently, the first metal ink 10A is mixed with ethanol to generate the second metal ink 10B (step S14). Herein, it is preferable that the second metal ink 10B is produced by mixing the first metal ink 10A with ethanol and water such that the amounts of metal particles 12, polyhydric alcohol 14, and ethanol are in the numerical ranges described above. The first metal ink 10A and ethanol may be mixed by any method. For example, the first metal ink 10A obtained at step S12 may be allowed to stand still for a predetermined period of time (for example, about 1 day) or centrifuged under predetermined conditions, then some of the supernatant may be removed, and ethanol may be added to the first metal ink 10A from which the supernatant has been removed.

### Production of Third Metal Ink

Subsequently, the second metal ink 10B is mixed with a high-boiling solvent and a dispersant to generate the third metal ink 10C (step S16). Herein, it is preferable that the third metal ink 10C is produced by mixing the second metal ink 10B, a high-boiling solvent, and a dispersant such that the amounts of metal particles 12, polyhydric alcohol 14, high-boiling solvent, and dispersant are in the numerical ranges described above. The second metal ink 10B, the high-boiling solvent, and the dispersant may be mixed by any method. For example, the second metal ink 10B obtained at step S14 may be allowed to stand still for a predetermined period of time (for example, about 1 day) or centrifuged under predetermined conditions, then some of the supernatant may be removed, and the high-boiling solvent may be added to the second metal ink 10B from which the supernatant solution has been removed. The addition of a dispersant is not essential.

The solvent (water, ethanol, high-boiling solvent, etc.) may be further removed from or added to the third metal ink 10C to achieve the numerical ranges described above.

The third metal ink 10C thus generated is used as the metal ink 10. In the description above, the second metal ink 10B is generated using the first metal ink 10A, and the third metal ink 10C is generated using the second metal ink 10C. In other words, the first metal ink 10A and the second metal ink 10B are intermediate substances for producing the third metal ink 10C. However, the first metal ink 10A and the second metal ink 10B are not necessarily intermediate substances, and the first metal ink 10A and the second metal ink 10B themselves may be used as the metal ink 10.

The method for manufacturing the metal particles 12 and the metal ink 10 described above are by way of example, and the metal particles 12 and the metal ink 10 may be manufactured by any method.

### Effects

As explained above, the metal ink 10 according to the present embodiment contains the metal particles 12, the solvent 16, and the polyhydric alcohol 14 that contains two or more OH groups and is soluble in water and ethanol. Herein, the metal particles may agglomerate in the metal ink in which the metal particles are dispersed in a solvent. The agglomeration of metal particles may lead to degradation of the characteristics of products, such as decrease in the denseness of the metal layer. In contrast, since the metal ink 10 according to the present embodiment contains the polyhydric alcohol 14, the agglomeration of the metal particles 12 can be suppressed by the polyhydric alcohol 14. In the metal ink 10 according to the present embodiment, the agglomeration of the metal particles 12 can be suppressed, and thus degradation of the characteristics of products can be suppressed. Furthermore, for example, when the metal ink 10 is ejected through a nozzle, production defects such as nozzle clogging can also be suppressed by suppressing the agglomeration of the metal particles 12.

In the method for manufacturing the metal ink 10 according to the present embodiment, the metal particles 12, the solvent 16, and the polyhydric alcohol 14 that contains two or more OH groups and is soluble in water and ethanol are mixed to manufacture the metal ink 10 containing the metal particles 12, the solvent 16, and the polyhydric alcohol 14. In this production method, the addition of the polyhydric alcohol 14 can suppress agglomeration of the metal particles 12.

### EXAMPLES

Examples will now be described. Tables 1 to 15 list the amounts of components of the metal inks and the evaluation results in examples.

TABLE 1

| | | | | Example | Example | Example | Example | Example | Example | Example |
|---|---|---|---|---|---|---|---|---|---|---|
| | Component | Substance name | Unit | 1 | 2 | 3 | 4 | 5 | 6 | 7 |
| Ink | Metal | Copper | Mass (g) | 9.0 | 9.0 | 9.0 | 9.0 | 9.0 | 9.0 | 9.0 |
| components | particles | | Content ratio | 13.6 | 13.6 | 13.6 | 13.6 | 13.6 | 13.6 | 8.3 |
| and | | | (% by mass) | | | | | | | |
| composition | | Silver | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Water | Water | Mass (g) | 55.2 | 53.5 | 50.5 | 47.0 | 43.8 | 43.2 | 11.0 |
| | | | Content ratio | 83.7 | 81.1 | 76.6 | 71.2 | 66.4 | 65.5 | 10.2 |
| | | | (% by mass) | | | | | | | |
| | Polyhydric | 2,22-Dimethyl-1,3- | Mass (g) | 1.8 | 3.5 | 6.5 | 10.0 | 13.2 | 13.8 | 0.3 |
| | alcohol | propanediol | Content ratio | 2.7 | 5.3 | 9.8 | 15.2 | 20.0 | 20.9 | 0.3 |
| | | | (% by mass) | | | | | | | |
| | | 1,1,1- | Mass (g) | 0 | 0 | 0 | 0 | 0 | 0 | 0 |
| | | Tris(hydroxymethyl) | Content ratio | 0 | 0 | 0 | 0 | 0 | 0 | 0 |
| | | propane | (% by mass) | | | | | | | |
| | | 2,5-Dimethyl-2,5- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | 2-Hydroxymethyl-2- | Mass (g) | 0 | 0 | 0 | 0 | 0 | 0 | 0 |
| | | methyl-1,3- | Content ratio | 0 | 0 | 0 | 0 | 0 | 0 | 0 |
| | | propanediol | (% by mass) | | | | | | | |
| | Other | Salicylic acid | Mass (g) | 0 | 0 | 0 | 0 | 0 | 0 | 0 |
| | than | | Content ratio | 0 | 0 | 0 | 0 | 0 | 0 | 0 |
| | polyhydric | | (% by mass) | | | | | | | |
| | alcohol | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 0 | 0 | 0 | 0 | 0 | 0 | 87.7 |
| | | | Content ratio | 0 | 0 | 0 | 0 | 0 | 0 | 81.2 |
| | | | (% by mass) | | | | | | | |
| | Dispersant | CRODAFOS O3A | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | High- | α-Terpineol | Mass (g) | 0 | 0 | 0 | 0 | 0 | 0 | 0 |
| | boiling | | Content ratio | 0 | 0 | 0 | 0 | 0 | 0 | 0 |
| | solvent | | (% by mass) | | | | | | | |
| | | 2-Ethyl-1,3- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | A | A | A | A | A | B | A |

### Example 1

In Example 1, copper phthalate was prepared as copper carboxylate as a starting material. Copper phthalate was put into ion-exchanged water at room temperature and stirred using a stirring blade to prepare an aqueous dispersion of copper phthalate with a concentration of 30% by mass. Then, an aqueous solution of ammonium phthalate was added as a pH adjuster to this aqueous solution of copper phthalate to adjust the pH of the above aqueous dispersion to 3. Subsequently, the pH-adjusted solution was set to 50° C., and under a nitrogen gas atmosphere, an aqueous solution of hydrazine monohydrate (2-fold dilution) with an oxidation-reduction potential of −0.5 V was added as a reducing agent in an amount 1.2 times the equivalent amount that can reduce copper ions to the pH-adjusted solution at once and mixed homogeneously using a stirring blade. Then, in order to synthesize the target copper particles (metal particles), the mixture of the aqueous dispersion and the reducing agent is heated to a holding temperature of 70° C. under a nitrogen gas atmosphere and held at 70° C. for 2 hours. Then, a water slurry of copper particles (copper powder concentration: 50% by mass) was obtained by dehydration and desalination using a centrifuge.

Then, 18 g of the obtained water slurry of copper particles (metal particles) (copper powder concentration: 50% by mass), 40 g of an aqueous solution of 2,2-dimethyl-1,3-propanediol (concentration: 5% by mass) as a polyhydric alcohol, and 16 g of water were mixed. After the mixture was left overnight, 8 g of the supernatant was removed to obtain 66 g of copper ink (metal ink) containing water as a solvent. The content ratio of each component of the copper ink in Example 1 was as listed in Table 1. The copper ink in Example 1 is an example of the first metal ink 10A of the present embodiment.

### Examples 2 to 6

In Examples 2 to 6, a copper ink (an example of the first metal ink 10A) was obtained in the same way as in Example 1, except that the blend ratio was as listed in Table 1.

### Example 7

In Example 7, 108 g of a copper ink (metal ink) containing ethanol as the main solvent was obtained by mixing 66 g of the copper ink obtained in Example 1 with 442 g of ethanol, leaving the mixture overnight, and removing 400 g of the supernatant. The content ratio of each component of the copper ink in Example 7 was as listed in Table 1. The copper ink in Example 7 is an example of the second metal ink 10B of the present embodiment.

TABLE 2

| | | | | Example | Example | Example | Example | Example | Example | Example |
|---|---|---|---|---|---|---|---|---|---|---|
| | Component | Substance name | Unit | 8 | 9 | 10 | 11 | 12 | 13 | 14 |
| Ink | Metal | Copper | Mass (g) | 9.0 | 9.0 | 9.0 | 9.0 | 9.0 | 9.0 | 9.0 |
| components | particles | | Content ratio | 23.5 | 50.0 | 52.9 | 23.6 | 13.6 | 13.6 | 13.6 |
| and | | | (% by mass) | | | | | | | |
| composition | | Silver | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Water | Water | Mass (g) | 1.6 | 0.5 | 0.5 | 1.6 | 55.2 | 53.5 | 50.5 |
| | | | Content ratio | 4.2 | 2.8 | 2.9 | 4.2 | 83.7 | 81.1 | 76.6 |
| | | | (% by mass) | | | | | | | |
| | Polyhydric | 2,22-Dimethyl-1,3- | Mass (g) | 0.1 | 0.1 | 0.1 | 0.1 | 0 | 0 | 0 |
| | alcohol | propanediol | Content ratio | 0.3 | 0.6 | 0.6 | 0.3 | 0 | 0 | 0 |
| | | | (% by mass) | | | | | | | |
| | | 1,1,1- | Mass (g) | 0 | 0 | 0 | 0 | 1.8 | 3.5 | 6.5 |
| | | Tris(hydroxymethyl) | Content ratio | 0 | 0 | 0 | 0 | 2.7 | 5.3 | 9.8 |
| | | propane | (% by mass) | | | | | | | |
| | | 2,5-Dimethyl-2,5- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | 2-Hydroxymethyl-2- | Mass (g) | 0 | 0 | 0 | 0 | 0 | 0 | 0 |
| | | methyl-1,3- | Content ratio | 0 | 0 | 0 | 0 | 0 | 0 | 0 |
| | | propanediol | (% by mass) | | | | | | | |
| | Other than | Salicylic acid | Mass (g) | 0 | 0 | 0 | 0 | 0 | 0 | 0 |
| | polyhydric | | Content ratio | 0 | 0 | 0 | 0 | 0 | 0 | 0 |
| | alcohol | | (% by mass) | | | | | | | |
| | | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 13.0 | 3.5 | 3.2 | 13.0 | 0 | 0 | 0 |
| | | | Content ratio | 33.8 | 19.4 | 18.8 | 33.9 | 0 | 0 | 0 |
| | | | (% by mass) | | | | | | | |
| | Dispersant | CRODAFOS O3A | Mass (g) | 0.1 | 0.2 | 0.2 | 0 | 0 | 0 | 0 |
| | | | Content ratio | 0.3 | 1.1 | 1.2 | 0 | 0 | 0 | 0 |
| | | | (% by mass) | | | | | | | |
| | High- | α-Terpineol | Mass (g) | 14.5 | 4.7 | 4.0 | 0 | 0 | 0 | 0 |
| | boiling | | Content ratio | 37.9 | 26.1 | 23.6 | 0 | 0 | 0 | 0 |
| | solvent | | (% by mass) | | | | | | | |
| | | 2-Ethyl-1,3- | Mass (g) | 0 | 0 | 0 | 14.5 | 0 | 0 | 0 |
| | | hexanediol | Content ratio | 0 | 0 | 0 | 38.0 | 0 | 0 | 0 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | A | A | A | A | A | A | A |

### Example 8

In Example 8, 51 g of a copper ink (metal ink) containing α-terpineol as the main solvent was obtained by mixing 108 g of the copper ink obtained in Example 7, 1 g of a dispersant (CRODAFOS O3A), and 98 g of α-terpineol as a high-boiling solvent, leaving the mixture overnight, and removing 156 g of the supernatant. The content ratio of each component of the copper ink in Example 8 was as listed in Table 2. The copper ink in Example 8 is an example of the third metal ink 10C of the present embodiment.

### Examples 9 and 10

In Examples 9 and 10, a copper ink (an example of the third metal ink 10C) was obtained in the same way as in Example 8, except that the blend ratio was as listed in Table 2.

### Example 11

In Example 11, 51 g of a copper ink (metal ink) containing 2-ethyl-1,3-hexanediol as the main solvent was obtained by mixing 108 g of the copper ink obtained in Example 7 with 99 g of 2-ethyl-1,3-hexanediol as a high-boiling solvent, leaving the mixture overnight, and removing 156 g of the supernatant. The content ratio of each component of the copper ink in Example 11 was as listed in Table 2. The copper ink in Example 11 is an example of the third metal ink 10C of the present embodiment.

TABLE 3

| | | | | Example | Example | Example | Example | Example | Example | Example |
|---|---|---|---|---|---|---|---|---|---|---|
| | Component | Substance name | Unit | 15 | 16 | 17 | 18 | 19 | 20 | 21 |
| Ink | Metal | Copper | Mass (g) | 9.0 | 9.0 | 9.0 | 9.0 | 9.0 | 9.0 | 9.0 |
| components | particles | | Content ratio | 13.6 | 13.6 | 13.6 | 8.3 | 23.5 | 50.0 | 52.9 |
| and | | | (% by mass) | | | | | | | |
| composition | | Silver | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Water | Water | Mass (g) | 47.0 | 43.8 | 43.2 | 11.0 | 1.6 | 0.5 | 0.5 |
| | | | Content ratio | 71.2 | 66.4 | 65.5 | 10.2 | 4.2 | 2.8 | 2.9 |
| | | | (% by mass) | | | | | | | |
| | Polyhydric | 2,22-Dimethyl-1,3- | Mass (g) | 0 | 0 | 0 | 0 | 0 | 0 | 0 |
| | alcohol | propanediol | Content ratio | 0 | 0 | 0 | 0 | 0 | 0 | 0 |
| | | | (% by mass) | | | | | | | |
| | | 1,1,1- | Mass (g) | 10.0 | 13.2 | 13.8 | 0.3 | 0.1 | 0.1 | 0.1 |
| | | Tris(hydroxymethyl) | Content ratio | 15.2 | 20.0 | 20.9 | 0.3 | 0.3 | 0.6 | 0.6 |
| | | propane | (% by mass) | | | | | | | |
| | | 2,5-Dimethyl-2,5- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | 2-Hydroxymethyl- | Mass (g) | 0 | 0 | 0 | 0 | 0 | 0 | 0 |
| | | 2-methyl-1,3- | Content ratio | 0 | 0 | 0 | 0 | 0 | 0 | 0 |
| | | propanediol | (% by mass) | | | | | | | |
| | Other than | Salicylic acid | Mass (g) | 0 | 0 | 0 | 0 | 0 | 0 | 0 |
| | polyhydric | | Content ratio | 0 | 0 | 0 | 0 | 0 | 0 | 0 |
| | alcohol | | (% by mass) | | | | | | | |
| | | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 0 | 0 | 0 | 87.7 | 13.0 | 3.5 | 3.2 |
| | | | Content ratio | 0 | 0 | 0 | 81.2 | 33.8 | 19.4 | 18.8 |
| | | | (% by mass) | | | | | | | |
| | Dispersant | CRODAFOS O3A | Mass (g) | 0 | 0 | 0 | 0 | 0.1 | 0.2 | 0.2 |
| | | | Content ratio | 0 | 0 | 0 | 0 | 0.3 | 1.1 | 1.2 |
| | | | (% by mass) | | | | | | | |
| | High- | α-Terpineol | Mass (g) | 0 | 0 | 0 | 0 | 14.5 | 4.7 | 4.0 |
| | boiling | | Content ratio | 0 | 0 | 0 | 0 | 37.9 | 26.1 | 23.6 |
| | solvent | | (% by mass) | | | | | | | |
| | | 2-Ethyl-1,3- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | A | A | B | A | A | A | A |

TABLE 4

| | | | | Example | Example | Example | Example | Example | Example | Example |
|---|---|---|---|---|---|---|---|---|---|---|
| | Component | Substance name | Unit | 22 | 23 | 24 | 25 | 26 | 27 | 28 |
| Ink | Metal | Copper | Mass (g) | 9.0 | 9.0 | 9.0 | 9.0 | 9.0 | 9.0 | 9.0 |
| components | particles | | Content ratio | 23.6 | 13.6 | 13.6 | 13.6 | 13.6 | 13.6 | 13.6 |
| and | | | (% by mass) | | | | | | | |
| composition | | Silver | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Water | Water | Mass (g) | 1.6 | 55.2 | 53.5 | 50.5 | 47.0 | 43.8 | 43.2 |
| | | | Content ratio | 4.2 | 83.7 | 81.1 | 76.6 | 71.2 | 66.4 | 65.5 |
| | | | (% by mass) | | | | | | | |
| | Polyhydric | 2,22-Dimethyl-1,3- | Mass (g) | 0 | 0 | 0 | 0 | 0 | 0 | 0 |
| | alcohol | propanediol | Content ratio | 0 | 0 | 0 | 0 | 0 | 0 | 0 |
| | | | (% by mass) | | | | | | | |
| | | 1,1,1- | Mass (g) | 0.1 | 0 | 0 | 0 | 0 | 0 | 0 |
| | | Tris(hydroxymethyl) | Content ratio | 0.3 | 0 | 0 | 0 | 0 | 0 | 0 |
| | | propane | (% by mass) | | | | | | | |
| | | 2,5-Dimethyl-2,5- | Mass (g) | 0 | 1.8 | 3.5 | 6.5 | 10.0 | 13.2 | 13.8 |
| | | hexanediol | Content ratio | 0 | 2.7 | 5.3 | 9.8 | 15.2 | 20.0 | 20.9 |
| | | | (% by mass) | | | | | | | |
| | | 2-Hydroxymethyl- | Mass (g) | 0 | 0 | 0 | 0 | 0 | 0 | 0 |
| | | 2-methyl-1,3- | Content ratio | 0 | 0 | 0 | 0 | 0 | 0 | 0 |
| | | propanediol | (% by mass) | | | | | | | |
| | Other than | Salicylic acid | Mass (g) | 0 | 0 | 0 | 0 | 0 | 0 | 0 |
| | polyhydric | | Content ratio | 0 | 0 | 0 | 0 | 0 | 0 | 0 |
| | alcohol | | (% by mass) | | | | | | | |
| | | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 13.0 | 0 | 0 | 0 | 0 | 0 | 0 |
| | | | Content ratio | 33.9 | 0 | 0 | 0 | 0 | 0 | 0 |
| | | | (% by mass) | | | | | | | |
| | Dispersant | CRODAFOS O3A | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | High- | α-Terpineol | Mass (g) | 0 | 0 | 0 | 0 | 0 | 0 | 0 |
| | boiling | | Content ratio | 0 | 0 | 0 | 0 | 0 | 0 | 0 |
| | solvent | | (% by mass) | | | | | | | |
| | | 2-Ethyl-1,3- | Mass (g) | 14.5 | 0 | 0 | 0 | 0 | 0 | 0 |
| | | hexanediol | Content ratio | 38.0 | 0 | 0 | 0 | 0 | 0 | 0 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | A | A | A | A | A | A | B |

### Examples 12 to 22

In Examples 12 to 22, a copper ink (an example of the first metal ink 10A, the second metal ink 10B, or the third metal ink 10C) was obtained in the same way as in Examples 1 to 11, except that 1,1,1-tris(hydroxymethyl)propane was used as a polyhydric alcohol and the blend ratio was as listed in Tables 2 to 4.

TABLE 5

| | | | | Example | Example | Example | Example | Example | Example | Example |
|---|---|---|---|---|---|---|---|---|---|---|
| | Component | Substance name | Unit | 29 | 30 | 31 | 32 | 33 | 34 | 35 |
| Ink | Metal | Copper | Mass (g) | 9.0 | 9.0 | 9.0 | 9.0 | 9.0 | 9.0 | 9.0 |
| components | particles | | Content ratio | 8.3 | 23.5 | 50.0 | 52.9 | 23.6 | 13.6 | 13.6 |
| and | | | (% by mass) | | | | | | | |
| composition | | Silver | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Water | Water | Mass (g) | 11.0 | 1.6 | 0.5 | 0.5 | 1.6 | 55.2 | 53.5 |
| | | | Content ratio | 10.2 | 4.2 | 2.8 | 2.9 | 4.2 | 83.7 | 81.1 |
| | | | (% by mass) | | | | | | | |
| | Polyhydric | 2,22-Dimethyl-1,3- | Mass (g) | 0 | 0 | 0 | 0 | 0 | 0 | 0 |
| | alcohol | propanediol | Content ratio | 0 | 0 | 0 | 0 | 0 | 0 | 0 |
| | | | (% by mass) | | | | | | | |
| | | 1,1,1- | Mass (g) | 0 | 0 | 0 | 0 | 0 | 0 | 0 |
| | | Tris(hydroxymethyl) | Content ratio | 0 | 0 | 0 | 0 | 0 | 0 | 0 |
| | | propane | (% by mass) | | | | | | | |
| | | 2,5-Dimethyl-2,5- | Mass (g) | 0.3 | 0.1 | 0.1 | 0.1 | 0.1 | 0 | 0 |
| | | hexanediol | Content ratio | 0.3 | 0.3 | 0.6 | 0.6 | 0.3 | 0 | 0 |
| | | | (% by mass) | | | | | | | |
| | | 2-Hydroxymethyl- | Mass (g) | 0 | 0 | 0 | 0 | 0 | 1.8 | 3.5 |
| | | 2-methyl-1,3- | Content ratio | 0 | 0 | 0 | 0 | 0 | 2.7 | 5.3 |
| | | propanediol | (% by mass) | | | | | | | |
| | Other than | Salicylic acid | Mass (g) | 0 | 0 | 0 | 0 | 0 | 0 | 0 |
| | polyhydric | | Content ratio | 0 | 0 | 0 | 0 | 0 | 0 | 0 |
| | alcohol | | (% by mass) | | | | | | | |
| | | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 87.7 | 13.0 | 3.5 | 3.2 | 13.0 | 0 | 0 |
| | | | Content ratio | 81.2 | 33.8 | 19.4 | 18.8 | 33.9 | 0 | 0 |
| | | | (% by mass) | | | | | | | |
| | Dispersant | CRODAFOS O3A | Mass (g) | 0 | 0.1 | 0.2 | 0.2 | 0 | 0 | 0 |
| | | | Content ratio | 0 | 0.3 | 1.1 | 1.2 | 0 | 0 | 0 |
| | | | (% by mass) | | | | | | | |
| | High- | α-Terpineol | Mass (g) | 0 | 14.5 | 4.7 | 4.0 | 0 | 0 | 0 |
| | boiling | | Content ratio | 0 | 37.9 | 26.1 | 23.6 | 0 | 0 | 0 |
| | solvent | | (% by mass) | | | | | | | |
| | | 2-Ethyl-1,3- | Mass (g) | 0 | 0 | 0 | 0 | 14.5 | 0 | 0 |
| | | hexanediol | Content ratio | 0 | 0 | 0 | 0 | 38.0 | 0 | 0 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | A | A | A | A | A | A | A |

### Examples 23 to 33

In Examples 23 to 33, a copper ink (an example of the first metal ink 10A, the second metal ink 10B, or the third metal ink 10C) was obtained in the same way as in Examples 1 to 11, except that 2,5-dimethyl-2,5-hexanediol was used as a polyhydric alcohol and the blend ratio was as listed in Tables 4 and 5.

TABLE 6

| | | | | Example | Example | Example | Example | Example | Example | Example |
|---|---|---|---|---|---|---|---|---|---|---|
| | Component | Substance name | Unit | 36 | 37 | 38 | 39 | 40 | 41 | 42 |
| Ink | Metal | Copper | Mass (g) | 9.0 | 9.0 | 9.0 | 9.0 | 9.0 | 9.0 | 9.0 |
| components | particles | | Content ratio | 13.6 | 13.6 | 13.6 | 13.6 | 8.3 | 23.5 | 50.0 |
| and | | | (% by mass) | | | | | | | |
| composition | | Silver | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Water | Water | Mass (g) | 50.5 | 47.0 | 43.8 | 43.2 | 11.0 | 1.6 | 0.5 |
| | | | Content ratio | 76.6 | 71.2 | 66.4 | 65.5 | 10.2 | 4.2 | 2.8 |
| | | | (% by mass) | | | | | | | |
| | Polyhydric | 2,22-Dimethyl-1,3- | Mass (g) | 0 | 0 | 0 | 0 | 0 | 0 | 0 |
| | alcohol | propanediol | Content ratio | 0 | 0 | 0 | 0 | 0 | 0 | 0 |
| | | | (% by mass) | | | | | | | |
| | | 1,1,1- | Mass (g) | 0 | 0 | 0 | 0 | 0 | 0 | 0 |
| | | Tris(hydroxymethyl) | Content ratio | 0 | 0 | 0 | 0 | 0 | 0 | 0 |
| | | propane | (% by mass) | | | | | | | |
| | | 2,5-Dimethyl-2,5- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | 2-Hydroxymethyl- | Mass (g) | 6.5 | 10.0 | 13.2 | 13.8 | 0.3 | 0.1 | 0.1 |
| | | 2-methyl-1,3- | Content ratio | 9.8 | 15.2 | 20.0 | 20.9 | 0.3 | 0.3 | 0.6 |
| | | propanediol | (% by mass) | | | | | | | |
| | Other than | Salicylic acid | Mass (g) | 0 | 0 | 0 | 0 | 0 | 0 | 0 |
| | polyhydric | | Content ratio | 0 | 0 | 0 | 0 | 0 | 0 | 0 |
| | alcohol | | (% by mass) | | | | | | | |
| | | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 0 | 0 | 0 | 0 | 87.7 | 13.0 | 3.5 |
| | | | Content ratio | 0 | 0 | 0 | 0 | 81.2 | 33.8 | 19.4 |
| | | | (% by mass) | | | | | | | |
| | Dispersant | CRODAFOS O3A | Mass (g) | 0 | 0 | 0 | 0 | 0 | 0.1 | 0.2 |
| | | | Content ratio | 0 | 0 | 0 | 0 | 0 | 0.3 | 1.1 |
| | | | (% by mass) | | | | | | | |
| | High- | α-Terpineol | Mass (g) | 0 | 0 | 0 | 0 | 0 | 14.5 | 4.7 |
| | boiling | | Content ratio | 0 | 0 | 0 | 0 | 0 | 37.9 | 26.1 |
| | solvent | | (% by mass) | | | | | | | |
| | | 2-Ethyl-1,3- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | A | A | A | B | A | A | A |

TABLE 7

| | | | | Example | Example | Example | Example | Example | Example | Example |
|---|---|---|---|---|---|---|---|---|---|---|
| | Component | Substance name | Unit | 43 | 44 | 45 | 46 | 47 | 48 | 49 |
| Ink | Metal | Copper | Mass (g) | 9.0 | 9.0 | 0 | 0 | 0 | 0 | 0 |
| components | particles | | Content ratio | 52.9 | 23.6 | 0 | 0 | 0 | 0 | 0 |
| and | | | (% by mass) | | | | | | | |
| composition | | Silver | Mass (g) | 0 | 0 | 8.0 | 8.0 | 8.0 | 8.0 | 8.0 |
| | | | Content ratio | 0 | 0 | 13.3 | 13.3 | 13.3 | 13.3 | 13.3 |
| | | | (% by mass) | | | | | | | |
| | Water | Water | Mass (g) | 0.5 | 1.6 | 50.5 | 48.5 | 46.0 | 43.0 | 40.0 |
| | | | Content ratio | 2.9 | 4.2 | 84.2 | 80.9 | 76.7 | 71.7 | 66.7 |
| | | | (% by mass) | | | | | | | |
| | Polyhydric | 2,22-Dimethyl-1,3- | Mass (g) | 0 | 0 | 1.5 | 3.5 | 6.0 | 9.0 | 12.0 |
| | alcohol | propanediol | Content ratio | 0 | 0 | 2.5 | 5.8 | 10.0 | 15.0 | 20.0 |
| | | | (% by mass) | | | | | | | |
| | | 1,1,1- | Mass (g) | 0 | 0 | 0 | 0 | 0 | 0 | 0 |
| | | Tris(hydroxymethyl) | Content ratio | 0 | 0 | 0 | 0 | 0 | 0 | 0 |
| | | propane | (% by mass) | | | | | | | |
| | | 2,5-Dimethyl-2,5- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | 2-Hydroxymethyl- | Mass (g) | 0.1 | 0.1 | 0 | 0 | 0 | 0 | 0 |
| | | 2-methyl-1,3- | Content ratio | 0.6 | 0.3 | 0 | 0 | 0 | 0 | 0 |
| | | propanediol | (% by mass) | | | | | | | |
| | Other than | Salicylic acid | Mass (g) | 0 | 0 | 0 | 0 | 0 | 0 | 0 |
| | polyhydric | | Content ratio | 0 | 0 | 0 | 0 | 0 | 0 | 0 |
| | alcohol | | (% by mass) | | | | | | | |
| | | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 3.2 | 13.0 | 0 | 0 | 0 | 0 | 0 |
| | | | Content ratio | 18.8 | 33.9 | 0 | 0 | 0 | 0 | 0 |
| | | | (% by mass) | | | | | | | |
| | Dispersant | CRODAFOS O3A | Mass (g) | 0.2 | 0 | 0 | 0 | 0 | 0 | 0 |
| | | | Content ratio | 1.2 | 0 | 0 | 0 | 0 | 0 | 0 |
| | | | (% by mass) | | | | | | | |
| | High- | α-Terpineol | Mass (g) | 4.0 | 0 | 0 | 0 | 0 | 0 | 0 |
| | boiling | | Content ratio | 23.6 | 0 | 0 | 0 | 0 | 0 | 0 |
| | solvent | | (% by mass) | | | | | | | |
| | | 2-Ethyl-1,3- | Mass (g) | 0 | 14.5 | 0 | 0 | 0 | 0 | 0 |
| | | hexanediol | Content ratio | 0 | 38.0 | 0 | 0 | 0 | 0 | 0 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | A | A | A | A | A | A | A |

### Examples 34 to 44

In Examples 34 to 44, a copper ink (an example of the first metal ink 10A, the second metal ink 10B, or the third metal ink 10C) was obtained in the same way as in Examples 1 to 11, except that 2-hydroxymethyl-2-methyl-1,3-propanediol was used as a polyhydric alcohol and the blend ratio was as listed in Tables 5 to 7.

### Example 45

In Example 45, while 1,200 g of ion-exchanged water held at 50° C. was stirred, 900 g of an aqueous silver nitrate solution (silver nitrate concentration: 66% by mass) held at 50° C. and 600 g of an aqueous ammonium citrate solution (citric acid concentration: 56% by mass) held at 50° C. were simultaneously added dropwise to the ion-exchanged water over 5 minutes to prepare a silver citrate slurry. Then, 300 g of an aqueous ammonium formate solution (formic acid concentration: 58% by mass) held at 50° C. was added dropwise as an aqueous reducing agent solution to the silver citrate slurry held at 50° C. over 30 minutes to obtain a mixed slurry.

Subsequently, the mixed slurry is heated to the maximum temperature of 70° C. at a temperature increase rate of 10° C./hour and held at 70° C. for 2 hours. The temperature was then decreased to 30° C. over 60 minutes. A silver particle slurry was thus obtained. This silver particle slurry was placed in a centrifuge and rotated at a rotation speed of 1000 rpm for 10 minutes to obtain a dehydrated and desalinated silver particle slurry.

Then, 16 g of the obtained water slurry of silver particles (metal particles) (silver particle concentration: 50% by mass), 36 g of an aqueous solution of 2,2-dimethyl-1,3-propanediol solution (concentration: 5% by mass) as a polyhydric alcohol, and 14 g of water are mixed. After the mixture was left overnight, 6 g of the supernatant was removed to obtain 60 g of a silver ink (metal ink) containing water as a solvent. The content ratio of each component of the silver ink in Example 45 was as listed in Table 7. The silver ink in Example 45 is an example of the first metal ink 10A of the present embodiment.

TABLE 8

| | | | | Example | Example | Example | Example | Example | Example | Example |
|---|---|---|---|---|---|---|---|---|---|---|
| | Component | Substance name | Unit | 50 | 51 | 52 | 53 | 54 | 55 | 56 |
| Ink | Metal | Copper | Mass (g) | 0 | 0 | 0 | 0 | 0 | 0 | 0 |
| components | particles | | Content ratio | 0 | 0 | 0 | 0 | 0 | 0 | 0 |
| and | | | (% by mass) | | | | | | | |
| composition | | Silver | Mass (g) | 8.0 | 8.0 | 8.0 | 8.0 | 8.0 | 8.0 | 8.0 |
| | | | Content ratio | 13.3 | 8.3 | 16.0 | 50.0 | 52.6 | 16.1 | 13.3 |
| | | | (% by mass) | | | | | | | |
| | Water | Water | Mass (g) | 39.5 | 9.5 | 2.1 | 0.5 | 0.5 | 2.1 | 50.5 |
| | | | Content ratio | 65.8 | 9.9 | 4.2 | 3.1 | 3.3 | 4.3 | 84.2 |
| | | | (% by mass) | | | | | | | |
| | Polyhydric | 2,22-Dimethyl-1,3- | Mass (g) | 12.6 | 0.3 | 0.04 | 0.1 | 0.1 | 0.04 | 0 |
| | alcohol | propanediol | Content ratio | 20.9 | 0.4 | 0.1 | 0.6 | 0.7 | 0.1 | 0 |
| | | | (% by mass) | | | | | | | |
| | | 1,1,1- | Mass (g) | 0 | 0 | 0 | 0 | 0 | 0 | 1.5 |
| | | Tris(hydroxymethyl) | Content ratio | 0 | 0 | 0 | 0 | 0 | 0 | 2.5 |
| | | propane | (% by mass) | | | | | | | |
| | | 2,5-Dimethyl-2,5- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | 2-Hydroxymethyl- | Mass (g) | 0 | 0 | 0 | 0 | 0 | 0 | 0 |
| | | 2-methyl-1,3- | Content ratio | 0 | 0 | 0 | 0 | 0 | 0 | 0 |
| | | propanediol | (% by mass) | | | | | | | |
| | Other than | Salicylic acid | Mass (g) | 0 | 0 | 0 | 0 | 0 | 0 | 0 |
| | polyhydric | | Content ratio | 0 | 0 | 0 | 0 | 0 | 0 | 0 |
| | alcohol | | (% by mass) | | | | | | | |
| | | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 0 | 78.1 | 17.6 | 3.2 | 2.8 | 17.6 | 0 |
| | | | Content ratio | 0 | 81.4 | 35.1 | 20.0 | 18.4 | 35.2 | 0 |
| | | | (% by mass) | | | | | | | |
| | Dispersant | CRODAFOS O3A | Mass (g) | 0 | 0 | 0.2 | 0.2 | 0.2 | 0 | 0 |
| | | | Content ratio | 0 | 0 | 0.5 | 1.3 | 1.3 | 0 | 0 |
| | | | (% by mass) | | | | | | | |
| | High- | α-Terpineol | Mass (g) | 0 | 0 | 22.0 | 4.0 | 3.6 | 0 | 0 |
| | boiling | | Content ratio | 0 | 0 | 44.1 | 25.0 | 23.7 | 0 | 0 |
| | solvent | | (% by mass) | | | | | | | |
| | | 2-Ethyl-1,3- | Mass (g) | 0 | 0 | 0 | 0 | 0 | 22.0 | 0 |
| | | hexanediol | Content ratio | 0 | 0 | 0 | 0 | 0 | 44.3 | 0 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | B | A | A | A | A | A | A |

### Examples 46 to 50

In Examples 46 to 50, a silver ink (an example of the first metal ink 10A) was obtained in the same way as in Example 45, except that the blend ratio was as listed in Tables 7 and 8.

### Example 51

In Example 51, 96 g of a silver ink (metal ink) containing ethanol as the main solvent was obtained by mixing 60 g of the silver ink obtained in Example 45 with 416 g of ethanol, leaving the mixture overnight, and removing 380 g of the supernatant. The content ratio of each component of the silver ink in Example 51 was as listed in Table 8. The silver ink in Example 51 is an example of the second metal ink 10B of the present embodiment.

### Example 52

In Example 52, 50 g of a silver ink (metal ink) containing α-terpineol as the main solvent was obtained by mixing 96 g of the silver ink obtained in Example 51, 1 g of a dispersant (CRODAFOS O3A), and 98 g of α-terpineol as a high-boiling solvent, leaving the mixture overnight, and removing 145 g of the supernatant. The content ratio of each component of the silver ink in Example 52 was as listed in Table 8. The silver ink in Example 52 is an example of the third metal ink 10C of the present embodiment.

### Examples 53 and 54

In Examples 53 and 54, a silver ink (an example of the third metal ink 10C) was obtained in the same way as in Example 52, except that the blend ratio was as listed in Table 8.

### Example 55

In Example 55, 50 g of a silver ink (metal ink) containing 2-ethyl-1,3-hexanediol as the main solvent was obtained by mixing 96 g of the silver ink obtained in Example 51 with 99 g of 2-ethyl-1,3-hexanediol as a high-boiling solvent, leaving the mixture overnight, and removing 145 g of the supernatant. The content ratio of each component of the silver ink in Example 55 was as listed in Table 8. The silver ink in Example 55 is an example of the third metal ink 10C of the present embodiment.

TABLE 9

| | | | | Example | Example | Example | Example | Example | Example | Example |
|---|---|---|---|---|---|---|---|---|---|---|
| | Component | Substance name | Unit | 57 | 58 | 59 | 60 | 61 | 62 | 63 |
| Ink | Metal | Copper | Mass (g) | 0 | 0 | 0 | 0 | 0 | 0 | 0 |
| components | particles | | Content ratio | 0 | 0 | 0 | 0 | 0 | 0 | 0 |
| and | | | (% by mass) | | | | | | | |
| composition | | Silver | Mass (g) | 8.0 | 8.0 | 8.0 | 8.0 | 8.0 | 8.0 | 8.0 |
| | | | Content ratio | 13.3 | 13.3 | 13.3 | 13.3 | 13.3 | 8.3 | 16.0 |
| | | | (% by mass) | | | | | | | |
| | Water | Water | Mass (g) | 48.5 | 46.0 | 43.0 | 40.0 | 39.5 | 9.5 | 2.1 |
| | | | Content ratio | 80.9 | 76.7 | 71.7 | 66.7 | 65.8 | 9.9 | 4.2 |
| | | | (% by mass) | | | | | | | |
| | Polyhydric | 2,22-Dimethyl-1,3- | Mass (g) | 0 | 0 | 0 | 0 | 0 | 0 | 0 |
| | alcohol | propanediol | Content ratio | 0 | 0 | 0 | 0 | 0 | 0 | 0 |
| | | | (% by mass) | | | | | | | |
| | | 1,1,1- | Mass (g) | 3.5 | 6.0 | 9.0 | 12.0 | 12.6 | 0.3 | 0.04 |
| | | Tris(hydroxymethyl) | Content ratio | 5.8 | 10.0 | 15.0 | 20.0 | 20.9 | 0.4 | 0.1 |
| | | propane | (% by mass) | | | | | | | |
| | | 2,5-Dimethyl-2,5- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | 2-Hydroxymethyl- | Mass (g) | 0 | 0 | 0 | 0 | 0 | 0 | 0 |
| | | 2-methyl-1,3- | Content ratio | | | | | | | |
| | | propanediol | (% by mass) | 0 | 0 | 0 | 0 | 0 | 0 | 0 |
| | Other than | Salicylic acid | Mass (g) | | | | | | | |
| | polyhydric | | Content ratio | 0 | 0 | 0 | 0 | 0 | 0 | 0 |
| | alcohol | | (% by mass) | 0 | 0 | 0 | 0 | 0 | 0 | 0 |
| | | 3,5- | Mass (g) | | | | | | | |
| | | Dihydroxybenzoic | Content ratio | 0 | 0 | 0 | 0 | 0 | 0 | 0 |
| | | acid | (% by mass) | 0 | 0 | 0 | 0 | 0 | 0 | 0 |
| | | Glutaric acid | Mass (g) | | | | | | | |
| | | | Content ratio | 0 | 0 | 0 | 0 | 0 | 0 | 0 |
| | | | (% by mass) | 0 | 0 | 0 | 0 | 0 | 0 | 0 |
| | | Ethylenediamine | Mass (g) | | | | | | | |
| | | | Content ratio | 0 | 0 | 0 | 0 | 0 | 0 | 0 |
| | | | (% by mass) | 0 | 0 | 0 | 0 | 0 | 0 | 0 |
| | Ethanol | Ethanol | Mass (g) | | | | | | | |
| | | | Content ratio | 0 | 0 | 0 | 0 | 0 | 78.1 | 17.6 |
| | | | (% by mass) | 0 | 0 | 0 | 0 | 0 | 81.4 | 35.1 |
| | Dispersant | CRODAFOS O3A | Mass (g) | | | | | | | |
| | | | Content ratio | 0 | 0 | 0 | 0 | 0 | 0 | 0.2 |
| | | | (% by mass) | 0 | 0 | 0 | 0 | 0 | 0 | 0.5 |
| | High- | α-Terpineol | Mass (g) | | | | | | | |
| | boiling | | Content ratio | 0 | 0 | 0 | 0 | 0 | 0 | 22.0 |
| | solvent | | (% by mass) | 0 | 0 | 0 | 0 | 0 | 0 | 44.1 |
| | | 2-Ethyl-1,3- | Mass (g) | | | | | | | |
| | | hexanediol | Content ratio | 0 | 0 | 0 | 0 | 0 | 0 | 0 |
| | | | (% by mass) | 0 | 0 | 0 | 0 | 0 | 0 | 0 |
| | | Dipropylene glycol | Mass (g) | | | | | | | |
| | | monomethyl ether | Content ratio | 0 | 0 | 0 | 0 | 0 | 0 | 0 |
| | | | (% by mass) | 0 | 0 | 0 | 0 | 0 | 0 | 0 |

| | | | | | | | | |
|---|---|---|---|---|---|---|---|---|
| Evaluation | Dispersibility | A | A | A | A | A | A | A |
| result | Sinterability | A | A | A | A | B | A | A |

TABLE 10

| | | | | Example | Example | Example | Example | Example | Example | Example |
|---|---|---|---|---|---|---|---|---|---|---|
| | Component | Substance name | Unit | 64 | 65 | 66 | 67 | 68 | 69 | 70 |
| Ink | Metal | Copper | Mass (g) | 0 | 0 | 0 | 0 | 0 | 0 | 0 |
| components | particles | | Content ratio | 0 | 0 | 0 | 0 | 0 | 0 | 0 |
| and | | | (% by mass) | | | | | | | |
| composition | | Silver | Mass (g) | 8.0 | 8.0 | 8.0 | 8.0 | 8.0 | 8.0 | 8.0 |
| | | | Content ratio | 50.0 | 52.6 | 16.1 | 13.3 | 13.3 | 13.3 | 13.3 |
| | | | (% by mass) | | | | | | | |
| | Water | Water | Mass (g) | 0.5 | 0.5 | 2.1 | 50.5 | 48.5 | 46.0 | 43.0 |
| | | | Content ratio | 3.1 | 3.3 | 4.3 | 84.2 | 80.9 | 76.7 | 71.7 |
| | | | (% by mass) | | | | | | | |
| | Polyhydric | 2,22-Dimethyl-1,3- | Mass (g) | 0 | 0 | 0 | 0 | 0 | 0 | 0 |
| | alcohol | propanediol | Content ratio | 0 | 0 | 0 | 0 | 0 | 0 | 0 |
| | | | (% by mass) | | | | | | | |
| | | 1,1,1- | Mass (g) | 0.1 | 0.1 | 0.04 | 0 | 0 | 0 | 0 |
| | | Tris(hydroxymethyl) | Content ratio | 0.6 | 0.7 | 0.1 | 0 | 0 | 0 | 0 |
| | | propane | (% by mass) | | | | | | | |
| | | 2,5-Dimethyl-2,5- | Mass (g) | 0 | 0 | 0 | 1.5 | 3.5 | 6.0 | 9.0 |
| | | hexanediol | Content ratio | 0 | 0 | 0 | 2.5 | 5.8 | 10.0 | 15.0 |
| | | | (% by mass) | | | | | | | |
| | | 2-Hydroxymethyl- | Mass (g) | 0 | 0 | 0 | 0 | 0 | 0 | 0 |
| | | 2-methyl-1,3- | Content ratio | 0 | 0 | 0 | 0 | 0 | 0 | 0 |
| | | propanediol | (% by mass) | | | | | | | |
| | Other than | Salicylic acid | Mass (g) | | | | | | | |
| | polyhydric | | Content ratio | 0 | 0 | 0 | 0 | 0 | 0 | 0 |
| | alcohol | | (% by mass) | 0 | 0 | 0 | 0 | 0 | 0 | 0 |
| | | 3,5- | Mass (g) | | | | | | | |
| | | Dihydroxybenzoic | Content ratio | 0 | 0 | 0 | 0 | 0 | 0 | 0 |
| | | acid | (% by mass) | 0 | 0 | 0 | 0 | 0 | 0 | 0 |
| | | Glutaric acid | Mass (g) | | | | | | | |
| | | | Content ratio | 0 | 0 | 0 | 0 | 0 | 0 | 0 |
| | | | (% by mass) | 0 | 0 | 0 | 0 | 0 | 0 | 0 |
| | | Ethylenediamine | Mass (g) | | | | | | | |
| | | | Content ratio | 0 | 0 | 0 | 0 | 0 | 0 | 0 |
| | | | (% by mass) | 0 | 0 | 0 | 0 | 0 | 0 | 0 |
| | Ethanol | Ethanol | Mass (g) | | | | | | | |
| | | | Content ratio | 3.2 | 2.8 | 17.6 | 0 | 0 | 0 | 0 |
| | | | (% by mass) | 20.0 | 18.4 | 35.2 | 0 | 0 | 0 | 0 |
| | Dispersant | CRODAFOS O3A | Mass (g) | | | | | | | |
| | | | Content ratio | 0.2 | 0.2 | 0 | 0 | 0 | 0 | 0 |
| | | | (% by mass) | 1.3 | 1.3 | 0 | 0 | 0 | 0 | 0 |
| | High- | α-Terpineol | Mass (g) | | | | | | | |
| | boiling | | Content ratio | 4.0 | 3.6 | 0 | 0 | 0 | 0 | 0 |
| | solvent | | (% by mass) | 25.0 | 23.7 | 0 | 0 | 0 | 0 | 0 |
| | | 2-Ethyl-1,3- | Mass (g) | | | | | | | |
| | | hexanediol | Content ratio | 0 | 0 | 22.0 | 0 | 0 | 0 | 0 |
| | | | (% by mass) | 0 | 0 | 44.3 | 0 | 0 | 0 | 0 |
| | | Dipropylene glycol | Mass (g) | | | | | | | |
| | | monomethyl ether | Content ratio | 0 | 0 | 0 | 0 | 0 | 0 | 0 |
| | | | (% by mass) | 0 | 0 | 0 | 0 | 0 | 0 | 0 |

| | | | | | | | | |
|---|---|---|---|---|---|---|---|---|
| Evaluation | Dispersibility | A | A | A | A | A | A | A |
| result | Sinterability | A | A | A | A | A | A | A |

### Examples 56 to 66

In Examples 56 to 66, a silver ink (an example of the first metal ink 10A, the second metal ink 10B, or the third metal ink 10C) was obtained in the same way as in Examples 45 to 55, except that 1,1,1-tris(hydroxymethyl)propane was used as a polyhydric alcohol and the blend ratio was as listed in Tables 8 to 10.

TABLE 11

| | | | | Example | Example | Example | Example | Example | Example | Example |
|---|---|---|---|---|---|---|---|---|---|---|
| | Component | Substance name | Unit | 71 | 72 | 73 | 74 | 75 | 76 | 77 |
| Ink | Metal | Copper | Mass (g) | 0 | 0 | 0 | 0 | 0 | 0 | 0 |
| components | particles | | Content ratio | 0 | 0 | 0 | 0 | 0 | 0 | 0 |
| and | | | (% by mass) | | | | | | | |
| composition | | Silver | Mass (g) | 8.0 | 8.0 | 8.0 | 8.0 | 8.0 | 8.0 | 8.0 |
| | | | Content ratio | 13.3 | 13.3 | 8.3 | 16.0 | 50.0 | 52.6 | 16.1 |
| | | | (% by mass) | | | | | | | |
| | Water | Water | Mass (g) | 40.0 | 39.5 | 9.5 | 2.1 | 0.5 | 0.5 | 2.1 |
| | | | Content ratio | 66.7 | 65.8 | 9.9 | 4.2 | 3.1 | 3.3 | 4.3 |
| | | | (% by mass) | | | | | | | |
| | Polyhydric | 2,22-Dimethyl-1,3- | Mass (g) | 0 | 0 | 0 | 0 | 0 | 0 | 0 |
| | alcohol | propanediol | Content ratio | 0 | 0 | 0 | 0 | 0 | 0 | 0 |
| | | | (% by mass) | | | | | | | |
| | | 1,1,1- | Mass (g) | 0 | 0 | 0 | 0 | 0 | 0 | 0 |
| | | Tris(hydroxymethyl) | Content ratio | 0 | 0 | 0 | 0 | 0 | 0 | 0 |
| | | propane | (% by mass) | | | | | | | |
| | | 2,5-Dimethyl-2,5- | Mass (g) | 12.0 | 12.6 | 0.3 | 0.04 | 0.1 | 0.1 | 0.04 |
| | | hexanediol | Content ratio | 20.0 | 20.9 | 0.4 | 0.1 | 0.6 | 0.7 | 0.1 |
| | | | (% by mass) | | | | | | | |
| | | 2-Hydroxymethyl- | Mass (g) | 0 | 0 | 0 | 0 | 0 | 0 | 0 |
| | | 2-methyl-1,3- | Content ratio | 0 | 0 | 0 | 0 | 0 | 0 | 0 |
| | | propanediol | (% by mass) | | | | | | | |
| | Other than | Salicylic acid | Mass (g) | 0 | 0 | 0 | 0 | 0 | 0 | 0 |
| | polyhydric | | Content ratio | 0 | 0 | 0 | 0 | 0 | 0 | 0 |
| | alcohol | | (% by mass) | | | | | | | |
| | | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 0 | 0 | 78.1 | 17.6 | 3.2 | 2.8 | 17.6 |
| | | | Content ratio | 0 | 0 | 81.4 | 35.1 | 20.0 | 18.4 | 35.2 |
| | | | (% by mass) | | | | | | | |
| | Dispersant | CRODAFOS O3A | Mass (g) | 0 | 0 | 0 | 0.2 | 0.2 | 0.2 | 0 |
| | | | Content ratio | 0 | 0 | 0 | 0.5 | 1.3 | 1.3 | 0 |
| | | | (% by mass) | | | | | | | |
| | High- | α-Terpineol | Mass (g) | 0 | 0 | 0 | 22.0 | 4.0 | 3.6 | 0 |
| | boiling | | Content ratio | 0 | 0 | 0 | 44.1 | 25.0 | 23.7 | 0 |
| | solvent | | (% by mass) | | | | | | | |
| | | 2-Ethyl-1,3- | Mass (g) | 0 | 0 | 0 | 0 | 0 | 0 | 22.0 |
| | | hexanediol | Content ratio | 0 | 0 | 0 | 0 | 0 | 0 | 44.3 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | A | B | A | A | A | A | A |

### Examples 67 to 77

In Examples 67 to 77, a silver ink (an example of the first metal ink 10A, the second metal ink 10B, or the third metal ink 10C) was obtained in the same way as in Examples 45 to 55, except that 2,5-dimethyl-2,5-hexanediol was used as a polyhydric alcohol and the blend ratio was as listed in Tables 10 and 11.

TABLE 12

| | | | | Example | Example | Example | Example | Example | Example | Example |
|---|---|---|---|---|---|---|---|---|---|---|
| | Component | Substance name | Unit | 78 | 79 | 80 | 81 | 82 | 83 | 84 |
| Ink | Metal | Copper | Mass (g) | 0 | 0 | 0 | 0 | 0 | 0 | 0 |
| components | particles | | Content ratio | 0 | 0 | 0 | 0 | 0 | 0 | 0 |
| and | | | (% by mass) | | | | | | | |
| composition | | Silver | Mass (g) | 8.0 | 8.0 | 8.0 | 8.0 | 8.0 | 8.0 | 8.0 |
| | | | Content ratio | 13.3 | 13.3 | 13.3 | 13.3 | 13.3 | 13.3 | 8.3 |
| | | | (% by mass) | | | | | | | |
| | Water | Water | Mass (g) | 50.5 | 48.5 | 46.0 | 43.0 | 40.0 | 39.5 | 9.5 |
| | | | Content ratio | 84.2 | 80.9 | 76.7 | 71.7 | 66.7 | 65.8 | 9.9 |
| | | | (% by mass) | | | | | | | |
| | Polyhydric | 2,22-Dimethyl-1,3- | Mass (g) | 0 | 0 | 0 | 0 | 0 | 0 | 0 |
| | alcohol | propanediol | Content ratio | 0 | 0 | 0 | 0 | 0 | 0 | 0 |
| | | | (% by mass) | | | | | | | |
| | | 1,1,1- | Mass (g) | 0 | 0 | 0 | 0 | 0 | 0 | 0 |
| | | Tris(hydroxymethyl) | Content ratio | 0 | 0 | 0 | 0 | 0 | 0 | 0 |
| | | propane | (% by mass) | | | | | | | |
| | | 2,5-Dimethyl-2,5- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | 2-Hydroxymethyl- | Mass (g) | 1.5 | 3.5 | 6.0 | 9.0 | 12.0 | 12.6 | 0.3 |
| | | 2-methyl-1,3- | Content ratio | 2.5 | 5.8 | 10.0 | 15.0 | 20.0 | 20.9 | 0.4 |
| | | propanediol | (% by mass) | | | | | | | |
| | Other than | Salicylic acid | Mass (g) | 0 | 0 | 0 | 0 | 0 | 0 | 0 |
| | polyhydric | | Content ratio | 0 | 0 | 0 | 0 | 0 | 0 | 0 |
| | alcohol | | (% by mass) | | | | | | | |
| | | 3,5- | Mass (g) | 0 | 0 | 0 | 0 | 0 | 0 | 0 |
| | | Dihydroxybenzoic | Content ratio | 0 | 0 | 0 | 0 | 0 | 0 | 0 |
| | | acid | (% by mass) | | | | | | | |
| | | Glutaric acid | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | | Ethylenediamine | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | Ethanol | Ethanol | Mass (g) | 0 | 0 | 0 | 0 | 0 | 0 | 78.1 |
| | | | Content ratio | 0 | 0 | 0 | 0 | 0 | 0 | 81.4 |
| | | | (% by mass) | | | | | | | |
| | Dispersant | CRODAFOS O3A | Mass (g) | 0 | 0 | 0 | 0 | 0 | 0 | 0 |
| | | | Content ratio | 0 | 0 | 0 | 0 | 0 | 0 | 0 |
| | | | (% by mass) | | | | | | | |
| | High- | α-Terpineol | Mass (g) | 0 | 0 | 0 | 0 | 0 | 0 | 0 |
| | boiling | | Content ratio | 0 | 0 | 0 | 0 | 0 | 0 | 0 |
| | solvent | | (% by mass) | | | | | | | |
| | | 2-Ethyl-1,3- | Mass (g) | 0 | 0 | 0 | 0 | 0 | 0 | 0 |
| | | hexanediol | Content ratio | 0 | 0 | 0 | 0 | 0 | 0 | 0 |
| | | | (% by mass) | | | | | | | |
| | | Dipropylene glycol | Mass (g) | 0 | 0 | 0 | 0 | 0 | 0 | 0 |
| | | monomethyl ether | Content ratio | 0 | 0 | 0 | 0 | 0 | 0 | 0 |
| | | | (% by mass) | | | | | | | |

| | | | | | | | | |
|---|---|---|---|---|---|---|---|---|
| Evaluation | Dispersibility | A | A | A | A | A | A | A |
| result | Sinterability | A | A | A | A | A | B | A |

TABLE 13

| | | | | Example | Example | Example | Example | Example | Example |
|---|---|---|---|---|---|---|---|---|---|
| | Component | Substance name | Unit | 85 | 86 | 87 | 88 | 89 | 90 |
| Ink | Metal | Copper | Mass (g) | 0 | 0 | 0 | 0 | 9.0 | 0 |
| components | particles | | Content ratio | 0 | 0 | 0 | 0 | 23.5 | 0 |
| and | | | (% by mass) | | | | | | |
| composition | | Silver | Mass (g) | 8.0 | 8.0 | 8.0 | 8.0 | 0 | 8.0 |
| | | | Content ratio | 16.0 | 50.0 | 52.6 | 16.1 | 0 | 16.0 |
| | | | (% by mass) | | | | | | |
| | Water | Water | Mass (g) | 2.1 | 0.5 | 0.5 | 2.1 | 1.6 | 2.1 |
| | | | Content ratio | 4.2 | 3.1 | 3.3 | 4.3 | 4.2 | 4.2 |
| | | | (% by mass) | | | | | | |
| | Polyhydric | 2,22-Dimethyl-1,3- | Mass (g) | 0 | 0 | 0 | 0 | 0.1 | 0.04 |
| | alcohol | propanediol | Content ratio | 0 | 0 | 0 | 0 | 0.3 | 0.1 |
| | | | (% by mass) | | | | | | |
| | | 1,1,1- | Mass (g) | 0 | 0 | 0 | 0 | 0 | 0 |
| | | Tris(hydroxymethyl) | Content ratio | 0 | 0 | 0 | 0 | 0 | 0 |
| | | propane | (% by mass) | | | | | | |
| | | 2,5-Dimethyl-2,5- | Mass (g) | 0 | 0 | 0 | 0 | 0 | 0 |
| | | hexanediol | Content ratio | 0 | 0 | 0 | 0 | 0 | 0 |
| | | | (% by mass) | | | | | | |
| | | 2-Hydroxymethyl- | Mass (g) | 0.04 | 0.1 | 0.1 | 0.04 | 0 | 0 |
| | | 2-methyl-1,3- | Content ratio | 0.1 | 0.6 | 0.7 | 0.1 | 0 | 0 |
| | | propanediol | (% by mass) | | | | | | |
| | Other than | Salicylic acid | Mass (g) | 0 | 0 | 0 | 0 | 0 | 0 |
| | polyhydric | | Content ratio | 0 | 0 | 0 | 0 | 0 | 0 |
| | alcohol | | (% by mass) | | | | | | |
| | | 3,5- | Mass (g) | 0 | 0 | 0 | 0 | 0 | 0 |
| | | Dihydroxybenzoic | Content ratio | 0 | 0 | 0 | 0 | 0 | 0 |
| | | acid | (% by mass) | | | | | | |
| | | Glutaric acid | Mass (g) | 0 | 0 | 0 | 0 | 0 | 0 |
| | | | Content ratio | 0 | 0 | 0 | 0 | 0 | 0 |
| | | | (% by mass) | | | | | | |
| | | Ethylenediamine | Mass (g) | 0 | 0 | 0 | 0 | 0 | 0 |
| | | | Content ratio | 0 | 0 | 0 | 0 | 0 | 0 |
| | | | (% by mass) | | | | | | |
| | Ethanol | Ethanol | Mass (g) | 17.6 | 3.2 | 2.8 | 17.6 | 13.0 | 17.6 |
| | | | Content ratio | 35.1 | 20.0 | 18.4 | 35.2 | 33.8 | 35.1 |
| | | | (% by mass) | | | | | | |
| | Dispersant | CRODAFOS O3A | Mass (g) | 0.2 | 0.2 | 0.2 | 0 | 0.1 | 0.2 |
| | | | Content ratio | 0.5 | 1.3 | 1.3 | 0 | 0.3 | 0.5 |
| | | | (% by mass) | | | | | | |
| | High- | α-Terpineol | Mass (g) | 22.0 | 4.0 | 3.6 | 0 | 0 | 0 |
| | boiling | | Content ratio | 44.1 | 25.0 | 23.7 | 0 | 0 | 0 |
| | solvent | | (% by mass) | | | | | | |
| | | 2-Ethyl-1,3- | Mass (g) | 0 | 0 | 0 | 22.0 | 0 | 0 |
| | | hexanediol | Content ratio | 0 | 0 | 0 | 44.3 | 0 | 0 |
| | | | (% by mass) | | | | | | |
| | | Dipropylene glycol | Mass (g) | 0 | 0 | 0 | 0 | 14.5 | 22.0 |
| | | monomethyl ether | Content ratio | 0 | 0 | 0 | 0 | 37.9 | 44.1 |
| | | | (% by mass) | | | | | | |

| Evaluation | Dispersibility | A | A | A | A | A | A |
|---|---|---|---|---|---|---|---|
| result | Sinterability | A | A | A | A | B | B |

### Examples 78 to 88

In Examples 78 to 88, a silver ink (an example of the first metal ink 10A, the second metal ink 10B, or the third metal ink 10C) was obtained in the same way as in Examples 45 to 55, except that 2-hydroxymethyl-2-methyl-1,3-propanediol was used as a polyhydric alcohol and the blend ratio was as listed in Tables 12 and 13.

### Example 89

In Example 89, the third metal ink 10C of the present embodiment was prepared in the same way as in Example 8, except that dipropylene glycol monomethyl ether was used as a high-boiling solvent. The content ratio of each component of the copper ink in Example 89 was as listed in Table 13.

### Example 90

In Example 90, the third metal ink 10C of the present embodiment was prepared in the same way as in Example 52, except that dipropylene glycol monomethyl ether was used as a high-boiling solvent. The content ratio of each component of the silver ink in Example 90 was as listed in Table 13.

TABLE 14

| | | | | Comparative | Comparative | Comparative | Comparative | Comparative |
|---|---|---|---|---|---|---|---|---|
| | Component | Substance name | Unit | Example 1 | Example 2 | Example 3 | Example 4 | Example 5 |
| Ink | Metal | Copper | Mass (g) | 9.0 | 9.0 | 9.0 | 9.0 | 9.0 |
| components | particles | | Content ratio | 14.0 | 13.6 | 13.6 | 13.6 | 13.6 |
| and | | | (% by mass) | | | | | |
| composition | | Silver | Mass (g) | 0 | 0 | 0 | 0 | 0 |
| | | | Content ratio | 0 | 0 | 0 | 0 | 0 |
| | | | (% by mass) | | | | | |
| | Water | Water | Mass (g) | 55.2 | 55.2 | 55.2 | 55.2 | 55.2 |
| | | | Content ratio | 86.0 | 83.7 | 83.7 | 83.7 | 83.7 |
| | | | (% by mass) | | | | | |
| | Polyhydric | 2,22-Dimethyl-1,3- | Mass (g) | 0 | 0 | 0 | 0 | 0 |
| | alcohol | propanediol | Content ratio | 0 | 0 | 0 | 0 | 0 |
| | | | (% by mass) | | | | | |
| | | 1,1,1- | Mass (g) | 0 | 0 | 0 | 0 | 0 |
| | | Tris(hydroxymethyl) | Content ratio | 0 | 0 | 0 | 0 | 0 |
| | | propane | (% by mass) | | | | | |
| | | 2,5-Dimethyl-2,5- | Mass (g) | 0 | 0 | 0 | 0 | 0 |
| | | hexanediol | Content ratio | 0 | 0 | 0 | 0 | 0 |
| | | | (% by mass) | | | | | |
| | | 2-Hydroxymethyl- | Mass (g) | 0 | 0 | 0 | 0 | 0 |
| | | 2-methyl-1,3- | Content ratio | 0 | 0 | 0 | 0 | 0 |
| | | propanediol | (% by mass) | | | | | |
| | Other than | Salicylic acid | Mass (g) | 0 | 1.8 | 0 | 0 | 0 |
| | polyhydric | | Content ratio | 0 | 2.7 | 0 | 0 | 0 |
| | alcohol | | (% by mass) | | | | | |
| | | 3,5- | Mass (g) | 0 | 0 | 1.8 | 0 | 0 |
| | | Dihydroxybenzoic | Content ratio | 0 | 0 | 2.7 | 0 | 0 |
| | | acid | (% by mass) | | | | | |
| | | Glutaric acid | Mass (g) | 0 | 0 | 0 | 1.8 | 0 |
| | | | Content ratio | 0 | 0 | 0 | 2.7 | 0 |
| | | | (% by mass) | | | | | |
| | | Ethylenediamine | Mass (g) | 0 | 0 | 0 | 0 | 1.8 |
| | | | Content ratio | 0 | 0 | 0 | 0 | 2.7 |
| | | | (% by mass) | | | | | |
| | Ethanol | Ethanol | Mass (g) | 0 | 0 | 0 | 0 | 0 |
| | | | Content ratio | 0 | 0 | 0 | 0 | 0 |
| | | | (% by mass) | | | | | |
| | Dispersant | CRODAFOS O3A | Mass (g) | 0 | 0 | 0 | 0 | 0 |
| | | | Content ratio | 0 | 0 | 0 | 0 | 0 |
| | | | (% by mass) | | | | | |
| | High- | α-Terpineol | Mass (g) | 0 | 0 | 0 | 0 | 0 |
| | boiling | | Content ratio | 0 | 0 | 0 | 0 | 0 |
| | solvent | | (% by mass) | | | | | |
| | | 2-Ethyl-1,3- | Mass (g) | 0 | 0 | 0 | 0 | 0 |
| | | hexanediol | Content ratio | 0 | 0 | 0 | 0 | 0 |
| | | | (% by mass) | | | | | |
| | | Dipropylene glycol | Mass (g) | 0 | 0 | 0 | 0 | 0 |
| | | monomethyl ether | Content ratio | 0 | 0 | 0 | 0 | 0 |
| | | | (% by mass) | | | | | |

| | | | | | | |
|---|---|---|---|---|---|---|
| Evaluation | Dispersibility | C | C | C | C | C |
| result | Sinterability | — | — | — | — | — |

| | | | | Comparative | Comparative |
|---|---|---|---|---|---|
| | Component | Substance name | Unit | Example 6 | Example 7 |
| Ink | Metal | Copper | Mass (g) | 9.0 | 0 |
| components | particles | | Content ratio | 8.4 | 0 |
| and | | | (% by mass) | | |
| composition | | Silver | Mass (g) | 0 | 8.0 |
| | | | Content ratio | 0 | 13.7 |
| | | | (% by mass) | | |
| | Water | Water | Mass (g) | 11.0 | 50.5 |
| | | | Content ratio | 10.2 | 86.3 |
| | | | (% by mass) | | |
| | Polyhydric | 2,22-Dimethyl-1,3- | Mass (g) | 0 | 0 |
| | alcohol | propanediol | Content ratio | 0 | 0 |
| | | | (% by mass) | | |
| | | 1,1,1- | Mass (g) | 0 | 0 |
| | | Tris(hydroxymethyl) | Content ratio | 0 | 0 |
| | | propane | (% by mass) | | |
| | | 2,5-Dimethyl-2,5- | Mass (g) | 0 | 0 |
| | | hexanediol | Content ratio | 0 | 0 |
| | | | (% by mass) | | |
| | | 2-Hydroxymethyl- | Mass (g) | 0 | 0 |
| | | 2-methyl-1,3- | Content ratio | 0 | 0 |
| | | propanediol | (% by mass) | | |
| | Other than | Salicylic acid | Mass (g) | 0 | 0 |
| | polyhydric | | Content ratio | 0 | 0 |
| | alcohol | | (% by mass) | | |
| | | 3,5- | Mass (g) | 0 | 0 |
| | | Dihydroxybenzoic | Content ratio | 0 | 0 |
| | | acid | (% by mass) | | |
| | | Glutaric acid | Mass (g) | 0 | 0 |
| | | | Content ratio | 0 | 0 |
| | | | (% by mass) | | |
| | | Ethylenediamine | Mass (g) | 0 | 0 |
| | | | Content ratio | 0 | 0 |
| | | | (% by mass) | | |
| | Ethanol | Ethanol | Mass (g) | 87.7 | 0 |
| | | | Content ratio | 81.4 | 0 |
| | | | (% by mass) | | |
| | Dispersant | CRODAFOS O3A | Mass (g) | 0 | 0 |
| | | | Content ratio | 0 | 0 |
| | | | (% by mass) | | |
| | High- | α-Terpineol | Mass (g) | 0 | 0 |
| | boiling | | Content ratio | 0 | 0 |
| | solvent | | (% by mass) | | |
| | | 2-Ethyl-1,3- | Mass (g) | 0 | 0 |
| | | hexanediol | Content ratio | 0 | 0 |
| | | | (% by mass) | | |
| | | Dipropylene glycol | Mass (g) | 0 | 0 |
| | | monomethyl ether | Content ratio | 0 | 0 |
| | | | (% by mass) | | |

| | | | |
|---|---|---|---|
| Evaluation | Dispersibility | C | C |
| result | Sinterability | — | — |

### Comparative Examples 1 to 6

In Comparative Examples 1 to 6, 18 g of the water slurry of copper particles (metal particles) (copper particle concentration: 50% by mass) obtained in Example 1 was used.

In a copper ink in Comparative Example 1, the first metal ink 10A of the present embodiment was produced without using polyhydric alcohol. In copper inks in Comparative Examples 2 to 5, the first metal ink 10A of the present embodiment was produced using salicylic acid, 3,5-dihydroxybenzoic acid, glutaric acid, and ethylenediamine, respectively, as substances other than polyhydric alcohol, instead of polyhydric alcohol. In a copper ink in Comparative Example 6, the second metal ink 10B of the present embodiment was produced without using polyhydric alcohol. The content ratio of each component of the copper inks in Comparative Examples 1 to 6 was as listed in Table 14.

TABLE 15

| | | | | Comparative | Comparative | Comparative | Comparative | Comparative |
|---|---|---|---|---|---|---|---|---|
| | Component | Substance name | Unit | Example 8 | Example 9 | Example 10 | Example 11 | Example 12 |
| Ink | Metal | Copper | Mass (g) | 0 | 0 | 0 | 0 | 0 |
| components | particles | | Content ratio | 0 | 0 | 0 | 0 | 0 |
| and | | | (% by mass) | | | | | |
| composition | | Silver | Mass (g) | 8.0 | 8.0 | 8.0 | 8.0 | 8.0 |
| | | | Content ratio | 13.3 | 13.3 | 13.3 | 13.3 | 8.4 |
| | | | (% by mass) | | | | | |
| | Water | Water | Mass (g) | 50.5 | 50.5 | 50.5 | 50.5 | 9.5 |
| | | | Content ratio | 84.2 | 84.2 | 84.2 | 84.2 | 10.0 |
| | | | (% by mass) | | | | | |
| | Polyhydric | 2,22-Dimethyl-1,3- | Mass (g) | 0 | 0 | 0 | 0 | 0 |
| | alcohol | propanediol | Content ratio | 0 | 0 | 0 | 0 | 0 |
| | | | (% by mass) | | | | | |
| | | 1,1,1- | Mass (g) | 0 | 0 | 0 | 0 | 0 |
| | | Tris(hydroxymethyl) | Content ratio | 0 | 0 | 0 | 0 | 0 |
| | | propane | (% by mass) | | | | | |
| | | 2,5-Dimethyl-2,5- | Mass (g) | 0 | 0 | 0 | 0 | 0 |
| | | hexanediol | Content ratio | 0 | 0 | 0 | 0 | 0 |
| | | | (% by mass) | | | | | |
| | | 2-Hydroxymethyl- | Mass (g) | 0 | 0 | 0 | 0 | 0 |
| | | 2-methyl-1,3- | Content ratio | 0 | 0 | 0 | 0 | 0 |
| | | propanediol | (% by mass) | | | | | |
| | Other than | Salicylic acid | Mass (g) | 1.5 | 0 | 0 | 0 | 0 |
| | polyhydric | | Content ratio | 2.5 | 0 | 0 | 0 | 0 |
| | alcohol | | (% by mass) | | | | | |
| | | 3,5- | Mass (g) | 0 | 1.5 | 0 | 0 | 0 |
| | | Dihydroxybenzoic | Content ratio | 0 | 2.5 | 0 | 0 | 0 |
| | | acid | (% by mass) | | | | | |
| | | Glutaric acid | Mass (g) | 0 | 0 | 1.5 | 0 | 0 |
| | | | Content ratio | 0 | 0 | 2.5 | 0 | 0 |
| | | | (% by mass) | | | | | |
| | | Ethylenediamine | Mass (g) | 0 | 0 | 0 | 1.5 | 0 |
| | | | Content ratio | 0 | 0 | 0 | 2.5 | 0 |
| | | | (% by mass) | | | | | |
| | Ethanol | Ethanol | Mass (g) | 0 | 0 | 0 | 0 | 78.1 |
| | | | Content ratio | 0 | 0 | 0 | 0 | 81.6 |
| | | | (% by mass) | | | | | |
| | Dispersant | CRODAFOS O3A | Mass (g) | 0 | 0 | 0 | 0 | 0 |
| | | | Content ratio | 0 | 0 | 0 | 0 | 0 |
| | | | (% by mass) | | | | | |
| | High- | α-Terpineol | Mass (g) | 0 | 0 | 0 | 0 | 0 |
| | boiling | | Content ratio | 0 | 0 | 0 | 0 | 0 |
| | solvent | | (% by mass) | | | | | |
| | | 2-Ethyl-1,3- | Mass (g) | 0 | 0 | 0 | 0 | 0 |
| | | hexanediol | Content ratio | 0 | 0 | 0 | 0 | 0 |
| | | | (% by mass) | | | | | |
| | | Dipropylene glycol | Mass (g) | 0 | 0 | 0 | 0 | 0 |
| | | monomethyl ether | Content ratio | 0 | 0 | 0 | 0 | 0 |
| | | | (% by mass) | | | | | |

| | | | | | | |
|---|---|---|---|---|---|---|
| Evaluation | Dispersibility | C | C | C | C | C |
| result | Sinterability | — | — | — | — | — |

### Comparative Examples 7 to 12

In Comparative Examples 7 to 12, 16 g of the water slurry of silver particles (metal particles) (silver particle concentration: 50% by mass) obtained in Example 45 was used.

In a silver ink in Comparative Example 7, the first metal ink 10A of the present embodiment was produced without using polyhydric alcohol. In silver inks in Comparative Examples 8 to 11, the first metal ink 10A of the present embodiment was produced using salicylic acid, 3,5-dihydroxybenzoic acid, glutaric acid, and ethylenediamine, respectively, as substances other than polyhydric alcohol, instead of polyhydric alcohol. In a silver ink in Comparative Example 12, the second metal ink 10B of the present embodiment was produced without using polyhydric alcohol. The content ratio of each component of the silver inks in Comparative Examples 7 to 12 was as listed in Tables 14 and 15.

### Evaluation Method

As for the dispersibility of the metal inks obtained in the examples and comparative examples, those in which the metal particles did not settle or separate during ink production were classified as excellent “A” and those in which the metal particles settled or separated were classified as not acceptable “C”, where excellent “A” was considered as being acceptable. Whether the metal particles settled and separated was visually observed.

The metal ink with excellent “A” dispersibility in the examples was applied and dried in a size of 10 mm×10 mm by an inkjet device at the center on a polyimide film having a thickness of 100 μm and a size of 50 mm×50 mm. Then, the metal ink was heated at 200° C. for 30 seconds in a nitrogen atmosphere to obtain a metal ink sintered film with a thickness of about 1 to 3 μm. The sinterability was evaluated by observation of a cross section of the obtained sintered film by a scanning electron microscope (SEM, manufactured by Hitachi High-Tech Corporation, observation magnification 10,000×). In the cross-sectional SEM image, the sinterability was classified as excellent “A” when the percentage of voids in the film was 20% or less, classified as good “B” when the percentage was more than 20% and 30% or less, and classified as not acceptable “C” when the percentage was more than 30%.

### Evaluation Results

In the evaluation, the dispersibility and the sinterability were evaluated. As for the dispersibility, in all of Examples 1 to 90 containing a polyhydric alcohol, the dispersibility was evaluated as excellent “A”, suggesting that the agglomeration of metal particles can be suppressed. On the other hand, in Comparative Examples 1 to 12 containing no polyhydric alcohol, the dispersibility was evaluated as not acceptable “C”, suggesting that the agglomeration of metal particles fail to be suppressed.

As for the sinterability, all of the examples were evaluated as excellent “A” or good “B”, suggesting that satisfactory results are obtained. In particular, in all of the examples in which the polyhydric alcohol content ratio was 20.0% or less and the examples in which the predetermined high-boiling solvent was used, the sinterability was evaluated as excellent “A”, suggesting that the results are even more favorable.

On the other hand, in the comparative examples, the dispersibility of the ink was not acceptable “C”, and the metal particles in the ink agglomerated, settled and separated, so that the ink was unable to be applied to the film with the inkjet device, and the subsequent evaluation of sinterability was impossible. The sinterability was therefore evaluated as “-”.

Although the embodiments of the present invention have been described above, embodiments are not limited by the contents of these embodiments. The aforementioned components include those that can be readily conceived by those skilled in the art, those that are substantially identical, and those that come within the range of equivalence. Furthermore, the aforementioned components can be combined as appropriate. Furthermore, various omissions, substitutions, or modifications of the components can be made without departing from the spirit of the foregoing embodiments.

### REFERENCE SIGNS LIST

10 Metal ink
12 Metal particle
14 Polyhydric alcohol
16 Solvent

1. A metal ink comprising:
metal particles;
a solvent; and
a polyhydric alcohol containing two or more OH groups and soluble in water and ethanol.

2. The metal ink according to claim 1, wherein the polyhydric alcohol is contained in an amount of 0.01% or more and 20.0% or less in mass ratio to a total amount of the metal ink.

3. The metal ink according to claim 1, wherein the metal particles are contained in an amount of 1.0% or more and 50.0% or less in mass ratio to a total amount of the metal ink.

4. The metal ink according to claim 1, wherein the polyhydric alcohol has a melting point of 30° C. or more.

5. The metal ink according to claim 1, wherein the solvent includes water.

6. The metal ink according to claim 1, wherein the solvent includes ethanol.

7. The metal ink according to claim 1, wherein the solvent includes a high-boiling solvent that contains one or more OH groups, has a boiling point of 150° C. or more, and is a liquid hardly soluble or insoluble in water.

8. The metal ink according to claim 1, wherein the metal particles are at least one of copper and silver.

9. A method for manufacturing a metal ink, comprising mixing metal particles, a solvent, and a polyhydric alcohol containing two or more OH groups and soluble in water and ethanol to manufacture a metal ink containing the metal particles, the solvent, and the polyhydric alcohol.

10. The method for manufacturing a metal ink according to claim 9, comprising mixing the metal particles with an aqueous solution of the polyhydric alcohol to produce a first metal ink that is a metal ink containing the metal particles, water, and the polyhydric alcohol.

11. The method for manufacturing a metal ink according to claim 10, comprising mixing the first metal ink with ethanol to produce a second metal ink that is a metal ink containing the metal particles, the ethanol, and the polyhydric alcohol.

12. The method for manufacturing a metal ink according to claim 11, comprising mixing the second metal ink with a high-boiling solvent that contains one or more OH groups, has a boiling point of 150° C. or more, and is a liquid hardly soluble or insoluble in water, to produce a third metal ink that is a metal ink containing the metal particles, the high-boiling solvent, and the polyhydric alcohol.

13. A method for manufacturing a metal layer, comprising heating the metal ink according to claim 1 to form a metal layer.
